(19) United States
(12) Patent Application Publication
(10) Pub. No.: US 2016/0026492 A1
(43) Pub. Date: Jan. 28, 2016

(54) ELECTRONIC APPARATUS FOR EXECUTING VIRTUAL MACHINE AND METHOD FOR EXECUTING VIRTUAL MACHINE

(71) Applicant: Samsung Electronics Co., Ltd., Suwon-si (KR)

(72) Inventors: Choon-Ho SON, Hwaseong-si (KR); Jun-Hee YOO, Suwon-si (KR); Hyung-Jin LIM, Seongnam-si (KR); Jung-Hyun YOO, Seoul (KR); Sung-Min LEE, Suwon-si (KR)

(21) Appl. No.: 14/807,408

(22) Filed: Jul. 23, 2015

Related U.S. Application Data
(60) Provisional application No. 62/028,593, filed on Jul. 24, 2014.

(30) Foreign Application Priority Data
Oct. 1, 2014 (KR) 10-2014-0132463

(51) Int. Cl. G06F 9/455; G06F 3/06

(52) U.S. Cl. CPC G06F 9/45558; G06F 3/0604; G06F 3/065; G06F 3/0664; G06F 3/0673; G06F 2009/45583; G06F 2009/45579

(57) ABSTRACT

A method for executing a virtual machine (VM) in an electronic device is provided. The method includes obtaining a position of a first base disk image stored in a disk image storage, creating a root disk image that backs the first base disk image based on the obtained position, and executing the VM based on the created root disk image. The method further includes, in the run-time of the VM, changing the first base disk to the second base disk, and continuing the VM based on the merged root disk.

### CROSS-REFERENCE TO RELATED APPLICATION(S)

This application claims the benefit under 35 U.S.C. §119(e) of a U.S. provisional patent application filed on Jul. 24, 2014 in the U.S. Patent and Trademark Office and assigned Ser. No. 62/028,593 and under 35 U.S.C. §119(a) of a Korean patent application filed on Oct. 1, 2014 in the Korean Intellectual Property Office and assigned Serial number 10-2014-0132463, the entire disclosure of each of which is hereby incorporated by reference.

### TECHNICAL FIELD

The present disclosure relates to an electronic device and a method for executing a virtual machine (VM).

### BACKGROUND

Recently, introduction of multiple servers using virtualization has been actively performed. Virtualization using one physical equipment maximizes the use of computing resources, such as a central processing unit (CPU), a memory, a storage, a network, and so forth, and operates and manages the resources for management of a large-scale data center. In virtualization, a virtual machine (VM) may be defined. The VM is a virtualization of a substantially physical server, and may include at least one virtual disk in the physical disk. A single host computer executing a virtual machine monitor (VMM) provides a plurality of host views or abstract pictures to enable host-based hardware to look like one or more VMs operating independently. The VM may function as a self-contained platform that executes an operating system (OS) or software applications. The VM stores a virtual disk image corresponding to the self-contained platform and provides a mode including a particular OS or application by using the stored virtual disk image.

As such, to run a VM in an electronic device, a virtual disk image needs to be stored. Meanwhile, if a virtual disk image corresponding to a required VM is not stored, an electronic device has to download the virtual disk image from a disk image storage. However, the amount of the virtual disk image is generally at a giga byte (GB) level, such that it takes a long time to download the virtual disk image.

Therefore, a need exists for an electronic device and a method for executing a virtual machine (VM).

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and a method for executing a virtual machine (VM).

Another aspect to be provided in the present disclosure may be understood by various embodiments described below.

In accordance with an aspect of the present disclosure, a method for executing a VM in an electronic device is provided. The method includes obtaining a position of a first base disk image stored in a disk image storage, creating a root disk image that backs the first base disk image based on the obtained position, and executing the VM based on the created root disk image.

In accordance with another aspect of the present disclosure, an electronic device for executing a VM is provided. The electronic device includes a communication interface configured to form communication connection with a disk image storage configured to store a first base disk image and a processor configured to obtain a position of a first base disk image stored in a disk image storage, to create a root disk image that backs the first base disk image based on the obtained position, and to execute the VM based on the created root disk image.

In accordance with another aspect of the present disclosure, a method for executing a VM in an electronic device is provided. The method includes executing the VM based on a root disk image that backs a first base disk image stored outside the electronic device, changing a backing target for the root disk image from the first base disk image to a second base disk image stored inside the electronic device, and resuming the VM based on the root disk image that backs the second base disk image.

In accordance with another aspect of the present disclosure, an electronic device for executing a VM is provided. The electronic device includes a communication interface configured to back a first base disk image stored outside the electronic device and a processor configured to execute the VM based on a root disk image that backs the first base disk image, in which the processor changes the backing target for the root disk image from the first base disk image to a second base disk image stored inside the electronic device, and resumes the VM based on the root disk image that backs the second base disk image.

In accordance with another aspect of the present disclosure, a method for executing a VM in an electronic device is provided. The method includes executing the VM based on a root disk image that backs a first base disk image stored outside the electronic device, downloading the first base disk image and storing a second base disk image inside the electronic device, merging the root disk image and the second base disk image to create a merged disk image, if the downloading of the first base disk image is completed, and resuming the VM based on the created merged disk image.

In accordance with another aspect of the present disclosure, an electronic device for executing a VM is provided. The electronic device includes a communication interface configured to back a first base disk image stored outside the electronic device, a processor configured to execute the VM based on a root disk image that backs the first base disk image, and a memory configured to download the first base disk image and to store a second base disk image, in which the processor merges the root disk image and the second base disk image to create a merged disk image, if the downloading of the first base disk image is completed, and resumes the VM based on the created merged disk image.

In accordance with another aspect of the present disclosure, a method for configuring a screen of an electronic device is provided. The method includes displaying a first screen based on a first environment, obtaining an environment change command requesting change from the first environment to a second environment, obtaining a position of a base disk image corresponding to the second environment, creating a root disk image that backs the base disk image, and displaying a second screen based on the second environment by executing a VM based on the root disk image.

In accordance with another aspect of the present disclosure, an electronic device is provided. The electronic device includes a display configured to display a first screen based on a first environment, an input/output interface configured to obtain an environment change command requesting change from the first environment to a second environment, and a processor configured to obtain a position of a base disk image corresponding to the second environment, to create a root disk image that backs the base disk image, and to display a second screen based on the second environment by executing a VM based on the root disk image.

In accordance with another aspect of the present disclosure, a method for executing a VM in an electronic device is provided. The method includes executing the VM by backing a first base disk image stored in a disk image storage and downloading the first base disk image in parallel with the backing.

In accordance with another aspect of the present disclosure, an electronic device for executing a VM is provided. The electronic device includes a processor configured to execute the VM by backing a first base disk image stored in a disk image storage and a communication interface configured to download the first base disk image in parallel with the backing.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of a certain embodiments of the present disclosure will be more apparent from the following description taken in conjunction with the accompanying drawings, in which:

FIG. 1A is a block diagram of an electronic device and a disk image storage according to an embodiment of the present disclosure;

FIG. 1B is a block diagram of an electronic device and a system according to an embodiment of the present disclosure;

FIG. 2 is a diagram illustrating a layer of a virtual machine (VM) according to an embodiment of the present disclosure;

FIG. 3 is a diagram illustrating a backing process according to an embodiment of the present disclosure;

FIG. 4 is a flowchart of a method for executing a VM according to an embodiment of the present disclosure;

FIG. 5 is a diagram illustrating a method for creating a VM according to an embodiment of the present disclosure;

FIG. 6 is a flowchart of a method for executing a VM according to an embodiment of the present disclosure;

FIGS. 7A, 7B, and 7C are diagrams illustrating a method for creating a VM according to an embodiment of the present disclosure;

FIG. 8 is a flowchart of a method for changing a backing file according to an embodiment of the present disclosure;

FIG. 9 is a diagram illustrating changing of a backing file according to an embodiment of the present disclosure;

FIG. 10 is a diagram illustrating an execution of a VM in a server according to an embodiment of the present disclosure;

FIG. 11 is a diagram illustrating creation of a streaming service according to an embodiment of the present disclosure;

FIG. 12 is a diagram illustrating an execution of a VM in a terminal device according to an embodiment of the present disclosure;

FIGS. 13A, 13B, 13C, 13D, and 13E are diagrams illustrating a screen configuration of an electronic device according to an embodiment of the present disclosure;

FIG. 14 is a flowchart of a method for controlling an electronic device according to an embodiment of the present disclosure;

FIG. 15 is a diagram illustrating a process of executing a VM according to an embodiment of the present disclosure;

FIGS. 16A and 16B are flowcharts of a process of executing a VM according to an embodiment of the present disclosure;

FIG. 17 is a diagram illustrating a process of executing a VM according to an embodiment of the present disclosure;

FIG. 18 is a flowchart of a method for executing a VM according to an embodiment of the present disclosure; and

FIG. 19 is a block diagram of an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terms “comprises” and/or “has” when used in this specification, specify the presence of a stated feature, number, operation, component, component, or a combination thereof but do not preclude the presence or addition of one or more other features, numbers, operations, components, components, or combinations thereof.

The term “or” or “at least one of A or/and B” used in the various embodiments of the present disclosure includes any and all combinations of the associated listed items. For example, the term “A or B” or “at least one of A or/and B” may indicate (1) “include at least one A”, (2) “include at least one B”, and (3) “include at least one A and at least one B”.

Although ordinal numbers, such as “first”, “second”, and so forth will be used to describe various components of the present disclosure, those components are not limited by the terms. The terms are used only for distinguishing one component from another component. For example, a first component may be referred to as a second component and likewise, a second component may also be referred to as a first component, without departing from the teaching of the present disclosure.

When it is described that a component, such as a first component, is “operatively or communicatively coupled” to or “connected” to another component, such as a second component, the component can be directly connected to the other component or can be connected to the other component through a third component. However, when it is described that a component, such as a first component, is “directly connected” or “directly coupled” to another component, such as a second component, it means that there is no intermediate component, such as a third component, between the component and the other component.

An expression “configured to (or set)” used in the present disclosure may be replaced with, for example, “suitable for,” “having the capacity to,” “designed to,” “adapted to,” “made to,” or “capable of” according to a situation. A term “configured to (or set)” does not always mean only “specifically designed to” by hardware. Alternatively, in some situation, an expression “apparatus configured to” may mean that the apparatus “can” operate together with another apparatus or component. For example, a phrase “a processor configured (or set) to perform A, B, and C” may be a generic-purpose processor, such as a central processing unit (CPU) or an application processor (AP), that can perform a corresponding operation by executing at least one software program stored at an exclusive processor, such as an embedded processor, for performing a corresponding operation or at a memory device.

Unless defined otherwise, all terms used herein have the same meanings as generally understood by those having ordinary knowledge in the technical field to which the present disclosure pertains. Terms generally used and defined in dictionaries should be interpreted as having meanings consistent with meanings construed in the context of the related art, and should not be interpreted as having ideal or excessively formal meanings unless defined explicitly in this application.

An electronic device according to various embodiments of the present disclosure may be a device including a communication function. For example, the electronic device may include at least one of a smart phone, a tablet personal computer (PC), a mobile phone, a video phone, an electronic book (e-book) reader, a desktop PC, a laptop PC, a netbook computer, a personal digital assistant (PDA), a portable multimedia player (PMP), a moving picture experts group (MPEG-1 or MPEG-2) audio layer III (MP3) player, mobile medical equipment, an electronic bracelet, an electronic necklace, an electronic appcessory, a camera, a wearable device (for example, a head-mounted device (HMD), such as electronic glasses), an electronic cloth, an electronic bracelet, an electronic necklace, an electronic appcessory, an electronic tattoo, a smart watch, and the like.

According to some embodiments of the present disclosure, the electronic device may be a smart home appliance which may include at least one of a television (TV), a digital video disc (DVD) player, audio equipment, a refrigerator, an air conditioner, a vacuum cleaner, an oven, a microwave oven, a laundry machine, an air cleaner, a set-top box, a TV box (for example, HomeSync™ of Samsung, TV™ of Apple, or TV™ of Google), a game console, an electronic dictionary, an electronic key, a camcorder, and an electronic frame. According to another embodiment of the present disclosure, the electronic device may include at least one of various medical equipment (for example, magnetic resonance angiography (MRA), magnetic resonance imaging (MRI), computed tomography (CT), an imaging device, or an ultrasonic device), a navigation system, a global positioning system (GPS) receiver, an event data recorder (EDR), a flight data recorder (FDR), a vehicle infotainment device, electronic equipment for ships (for example, navigation system and gyro compass for ships), avionics, a security device, a vehicle head unit, an industrial or home robot, an automatic teller's machine (ATM), a point of sales (POS), Internet of things (for example, electric bulbs, various sensors, electricity or gas meters, sprinkler devices, fire alarm devices, thermostats, streetlights, toasters, exercise machines, hot-water tanks, heaters, boilers, and so forth).

According to some embodiments of the present disclosure, the electronic device may include at least one of a part of a furniture or building/structure having a communication function, an electronic board, an electronic signature receiving device, a projector, and various measuring instruments (for example, a water, electricity, gas, or electric wave measuring device). The electronic device according to various embodiments of the present disclosure may be one of the above-listed devices or a combination thereof It will be obvious to those of ordinary skill in the art that the electronic device according to various embodiments of the present disclosure is not limited to the above-listed devices.

Hereinafter, an electronic device according to various embodiments of the present disclosure will be described with reference to the accompanying drawings. Herein, the term “user” used in various embodiments of the present disclosure may refer to a person who uses the electronic device or a device using the electronic device (for example, an artificial intelligence electronic device).

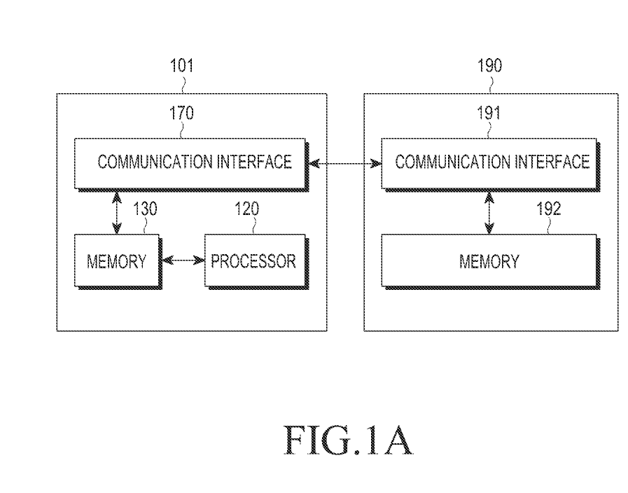

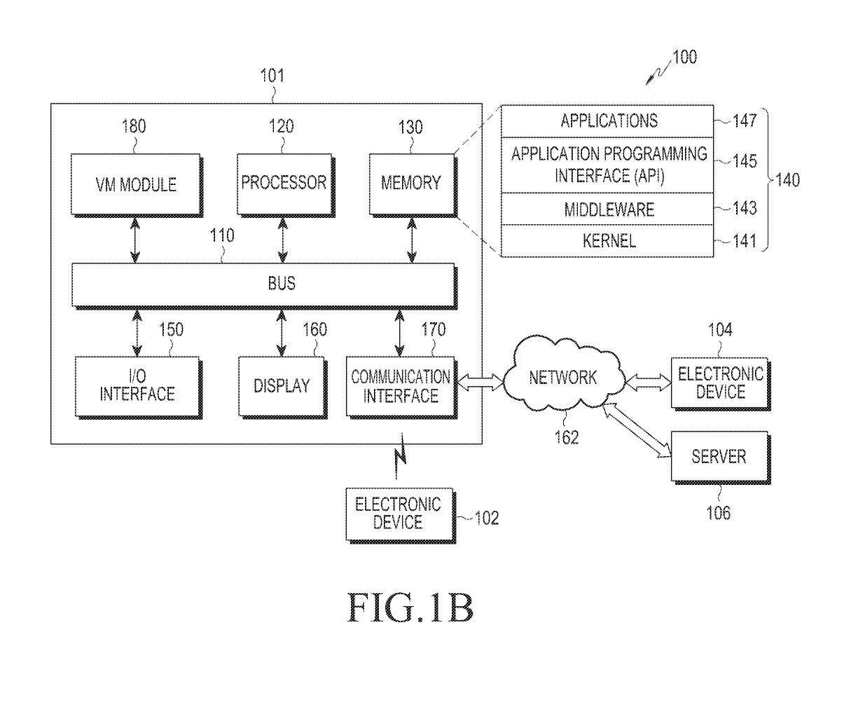

FIG. 1A is a block diagram of an electronic device and a disk image storage according to an embodiment of the present disclosure.

Referring to FIG. 1A, an electronic device 101 may include a processor 120, a memory 130, and a communication interface 170. A disk image storage 190 may include a communication interface 191 and a memory 192.

In an embodiment of the present disclosure, the processor 120 may execute a virtual machine (VM). For example, the processor 120 controls at least one hardware in the electronic device 101 to operate by at least one VMs through resource distribution to the at least one hardware. The processor 120 controls resource distribution such that the at least one VMs respectively use at least one hardware independently. Thus, the VMs may operate independently of each other.

The VM may include a virtual CPU and a virtual memory. Moreover, the VM may be executed using a disk image. The virtual disk image may be a file existing in a file system of a local disk attached in the form of a direct attached storage (DAS) or a network attached storage (NAS).

In an embodiment of the present disclosure, the processor 120 executes a VM based on a disk image stored in the memory 130. Herein, the disk image may be a computer file including a particular operating system (OS) and at least one applications. The disk image may be created based on sector-by-sector copies of the particular OS and the at least one applications. The processor 120 may process data input/output generated by an application or an OS on the VM by using a disk image.

In an embodiment of the present disclosure, the memory 130 may store a disk image.

In an embodiment of the present disclosure, the memory 130 may store a root disk image which backs a base disk image. The processor 120 may execute a VM based on the root disk image stored in the memory 130. The processor 120 may process data input/output generated by an application or an OS on the VM by using the root disk image. If the processor 120 may not be able to process data input/output generated by an application or an OS on the VM by using the root disk image, the processor 120 may process the data input/output by using the base disk image that the root disk image backs.

In an embodiment of the present disclosure, the communication interface 170 may form communication connection with the communication interface 191 of the disk image storage 190. As mentioned above, if the processor 120 may not be able to process data input/output generated by an application or an OS on the VM by using the root disk image, the communication interface 170 may transmit the non-processed data input/output to the communication interface 191 of the disk image storage 190. The communication interface 170 may receive a processing result corresponding to the data input/output from the communication interface 191 and deliver the received processing result to the processor 120. The processing result may be generated based on the base disk image. In this way, the processor 120 may process the data input/output generated by the application or the OS on the VM by using the root disk image or the base disk image that the root disk image backs.

In an embodiment of the present disclosure, the root disk image may be a write-only disk image and the base disk image may be a read-only disk image. In this embodiment, if write data is input, the processor 120 may process the data input/output by using the root disk image. If read data is input, the processor 120 may not be able to process the data input/output by using the root disk image, and thus may process the data input/output by using the base disk image.

In another embodiment of the present disclosure, the root disk image may be a disk image capable of performing write and read operations. In this embodiment, if read data is input, the processor 120 may determine whether the processor 120 may be able to process the read data by using the root disk image. If there is no read data in the root disk image, the processor 120 may process the read data by using the base disk image.

In an embodiment of the present disclosure, the communication interface 170 may receive the base disk image from the disk image storage 190. The communication interface 170 may receive the base disk image from the disk image storage 190 in parallel with the data input/output or transmission and reception of the processing result corresponding to the data input/output. The communication interface 170 may store the received base disk image in the memory 130. To facilitate identification, the base disk image stored in the memory 192 of the disk image storage 190, which is backed by the root disk image in the memory 130, may be referred to as a first base disk image, and the base disk image downloaded through the communication interface 170 and stored in the memory 130 may be referred to as a second base disk image.

In an embodiment of the present disclosure, if downloading of the base disk image is completed, the processor 120 may control the root disk image to back the second base disk image. More specifically, the processor 120 may change an object performing data input/output from a first object corresponding to the first base disk image with a second object corresponding to the second base disk image. For example, the processor 120 may stop the data input/output from the first object, and if changing to the second object is completed, the processor 120 may initiate data input/output from the second object.

In another embodiment of the present disclosure, if downloading of the base disk image is completed, the processor 120 may execute a VM based on a merged disk image generated by merging the root disk image and the second base disk image. More specifically, the processor 120 may execute the VM by directly using the merged disk image without using a backing process. The processor 120 may delete the second base disk image used in a merging process from the memory 130 after the merging process.

In an embodiment of the present disclosure, if downloading is completed, the communication interface 170 may release connection with the disk image storage 190.

In an embodiment of the present disclosure, the processor 120 may obtain a uniform resource locator (URL) of the first base disk image and back the first base disk image based on the obtained URL.

The memory 192 stores at least one base disk images.

The communication interface 191 receives a request for downloading the first base disk image from the electronic device 101. The communication interface 191 transmits the first base disk image stored in the memory 192 to the communication interface 170.

In an embodiment of the present disclosure, the communication interface 191 receives backing-related data of the root disk image stored in the electronic device 101 from the communication interface 170. The communication interface 191 transmits a processing result corresponding to the backing-related data to the communication interface 170.

FIG. 1B is a block diagram of an electronic device and a system according to an embodiment of the present disclosure.

Referring to FIG. 1B, an electronic device 101 in a network environment 100 according to various embodiments of the present disclosure is disclosed. The electronic device 101 may include a bus 110, a processor 120, a memory 130, an input/output (I/O) interface 150, a display 160, a communication interface 170, and a VM module 180. In some embodiments of the present disclosure, the electronic device 101 may omit at least one of the foregoing components or may further include other components. FIG. 1B illustrates the electronic device 101 implemented, for example, with a terminal device. Meanwhile, as will be described below, the electronic device 101 may also be implemented with a server device, such as a data center or a telecommunication server, as well as a terminal device.

The bus 110 may include a circuit for interconnecting the components 120 through 180 described above and for allowing communication (for example, a control message and/or data) between the components 120 through 180 described above.

The processor 120 may include one or more of a CPU, an AP, and a communication processor (CP). The processor 120 performs operations or data processing for control and/or communication of, for example, at least one other components of the electronic device 101. The processor 120 may be referred to as a controller or may include the controller as a part thereof

The memory 130 may include a volatile and/or nonvolatile memory. The memory 130 may store, for example, commands or data associated with at least one other components of the electronic device 101. According to an embodiment of the present disclosure, the memory 130 may store software and/or a program 140. The program 140 may include, for example, a kernel 141, middleware 143, an application programming interface (API) 145, and/or an application program (or an application) 147. At least some of the kernel 141, the middleware 143, and the API 145 may be referred to as an OS.

The kernel 141 controls or manages, for example, system resources (for example, the bus 110, the processor 120, or the memory 130) used to execute an operation or a function implemented in other programs (for example, the middleware 143, the API 145, or the application program 147). The kernel 141 provides an interface through which the middleware 143, the API 145, or the application program 147 accesses separate components of the electronic device 10 to control or manage the system resources.

The middleware 143 may work as an intermediary for allowing, for example, the API 145 or the application program 147 to exchange data in communication with the kernel 141. In regard to task requests received from the application program 147, the middleware 143 performs control (for example, scheduling or load balancing) with respect to the task requests, for example, by giving priorities for using a system resource (for example, the bus 110, the processor 120, or the memory 130) of the electronic device 101 to at least one of the application programs 147.

The API 145 is an interface used for the application 147 to control a function provided by the kernel 141 or the middleware 143, and may include, for example, at least one interface or function (for example, a command) for file control, window control, image processing or character control.

Herein, the application may be referred to as an application program.

The I/O interface 150 serves as an interface for delivering a command or data input from a user or another external device to other component(s) of the electronic device 101. The I/O interface 150 may also output a command or data received from other component(s) of the electronic device 101 to a user or another external device.

The display 160 may include, for example, a liquid crystal display (LCD), a light emitting diode (LED) display, an organic LED (OLED) display, a micro electro mechanical system (MEMS) display, or an electronic paper display. The display 160 may display various contents (for example, a text, an image, video, an icon, or a symbol) to users. The display 16 may include a touch screen, and receives a touch, a gesture, proximity, or a hovering input, for example, by using an electronic pen or a part of a body of a user.

The communication interface 170 sets up communication, for example, between the electronic device 101 and an external device (for example, a first external electronic device 102, a second external electronic device 104, or a server 106). For example, the communication interface 170 is connected to a network 162 through wireless or wired communication to communicate with the external device (for example, the second external electronic device 104 or the server 106).

The wireless communication may use, as a cellular communication protocol, for example, at least one of long term evolution (LTE), LTE-advanced (LTE-A), code division multiple access (CDMA), wideband CDMA (WCDMA), a universal mobile telecommunication system (UMTS), wireless broadband (WiBro), or global system for mobile communications (GSM)). The wired communication may include, for example, at least one of a universal serial bus (USB), a high definition multimedia interface (HDMI), a recommended standard (RS)-232, and a plain old telephone service (POTS). The network 21 may include a telecommunications network, for example, at least one of a computer network (for example, a local area network (LAN) or a wide area network (WAN)), Internet, and a telephone network.

Each of the first external electronic device 102 and the second external electronic device 104 may be a device of the same type as or a different type than the electronic device 101. According to an embodiment of the present disclosure, the server 106 may include a group of one or more servers. According to various embodiments of the present disclosure, some or all of operations performed by the electronic device 101 may be performed in other one or more electronic devices (for example, the first external electronic device 102 and the second external electronic device 104 or the server 106). According to an embodiment of the present disclosure, when the electronic device 101 has to perform a function or a service automatically or at a request, the electronic device 101 may request another device (for example, the first external electronic device 102 or the second external electronic device 104 or the server 106) to execute at least some functions associated with the function or the service, in place of or in addition to executing the function or the service. The another electronic device (for example, the first external electronic device 102 or the second external electronic device 104 or the server 106) may execute the requested function or additional function and deliver the execution result to the electronic device 101. The electronic device 101 may then process or further process the received result to provide the requested function or service. To this end, for example, cloud computing, distributed computing, or client-server computing may be used.

In an embodiment of the present disclosure, the VM module 180 may support driving of the electronic device 101 by performing at least one of operations (or functions) implemented in the electronic device 101. For example, the server 106 may include a VM server module (not illustrated) capable of supporting the VM module 180 implemented in the electronic device 101. For example, the VM module (not illustrated) may include at least one components to perform at least one of operations performed by the VM module 180 (for example, in place of the VM module 180).

The VM module 180 processes at least a part of information obtained from other components (for example, at least one of the processor 120, the memory 130, the I/O interface 150, and the communication interface 170), and uses the processed information in various ways. For example, the VM module 180 may control at least some functions of the electronic device 101 using or independently of the processor 120, such that the electronic device 101 operates with other devices (for example, the first external electronic device 102 or the second external electronic device 104 or the server 106). The VM module 180 may be integrated into the processor 120 or the communication interface 170. According to an embodiment of the present disclosure, at least one components of the VM module 180 may be included in the server 106 and at least one operations implemented in the VM module 180 may be supported by the server 106.

FIG. 2 is a diagram illustrating a layer of a VM according to an embodiment of the present disclosure.

Referring to FIG. 2, for example, a data processing layer of the electronic device 101 is illustrated. On a hardware layer 210, a hypervisor layer 220 may be defined. Depending on an embodiment of the present disclosure, the hypervisor may be called a virtual machine monitor (VMM). The hypervisor may refer to firmware or software that creates and executes a VM.

On the hypervisor layer 220, at least one VMs 230 and 240 may be executed. The first VM 230 may include a first OS layer 231 and a first application layer 232. The second VM 240 may include a second OS layer 241 and a second application layer 242. Herein, the first OS layer 231 and the second OS layer 241 may be independent of each other.

The hypervisor layer 220 distributes resources of the hardware layer 210 to the first VM 230 and the second VM 240. The hypervisor layer 220 performs resource distribution of the hardware layer 210 for data input/output from the first VM 230 and resource distribution of the hardware layer 210 for data input/output from the second VM 240. The hypervisor layer 220 may perform resource distribution such that the first VM 230 and the second VM 240 operate independently of each other.

The hypervisor layer 220 may process data input/output from the first VM 230 and the second VM 240 by using a disk image 250. While the first VM 230 and the second VM 240 are illustrated as corresponding to the same disk image 250 in FIG. 2, this illustration is merely an example and different disk images corresponding to the respective VMs 230 and 240 may exist.

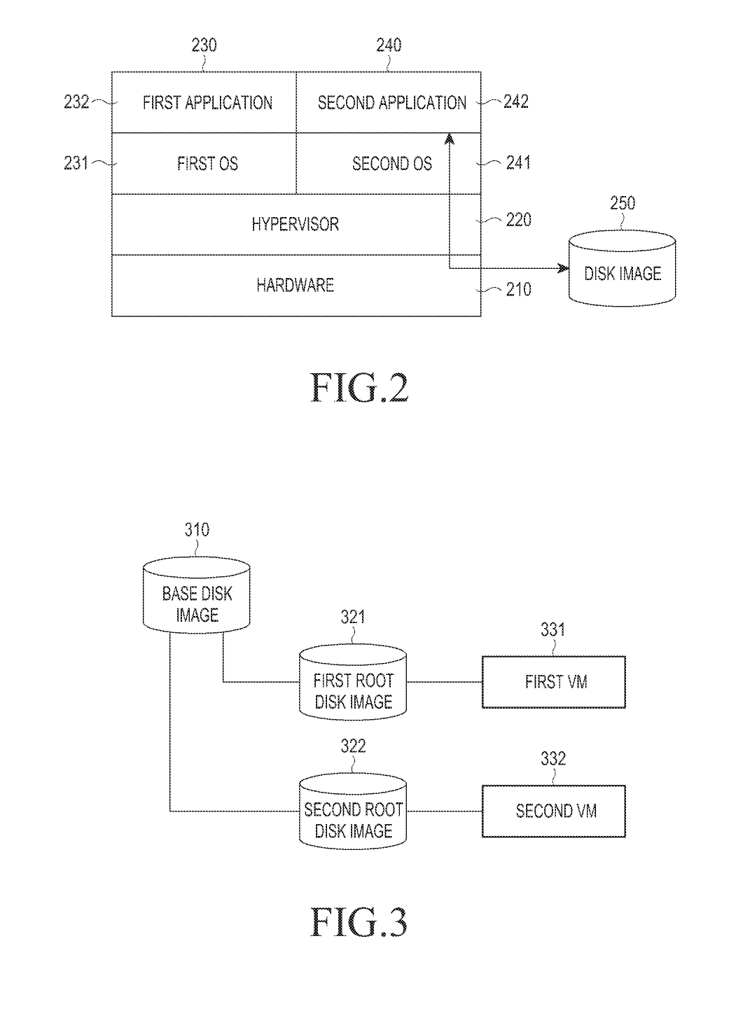

FIG. 3 is a diagram illustrating a backing process according to an embodiment of the present disclosure.

Referring to FIG. 3, a first VM 331 and a second VM 332 may be executed using a first root disk image 321 and a second root disk image 322.

In an embodiment of the present disclosure, a root disk image may be a write-only disk image. For example, if first write data is output from the first VM 331, the hypervisor may control the first write data to be stored in the root disk image. In another embodiment of the present disclosure, the root disk image may be a readable/writable disk image.

The first root disk image 321 may back a base disk image 310. For example, the base disk image 310 may be a read-only disk image. If read data is input, the hypervisor may process the read data by using the base disk image 310. If the root disk image is a readable/writable disk image, the hypervisor may first determine whether the hypervisor may be able to process the input read data by using the root disk image. If the hypervisor may not be able to process the input read data by using the root disk image, the hypervisor may process the read data by using the base disk image 310.

In the embodiment of FIG. 3, the first root disk image 321 and the second root disk image 322 both back one base disk image 310, but this illustration is merely an example. In another embodiment of the present disclosure, the first root disk image 321 and the second root disk image 322 may back different base disk images.

The base disk image 310 may be stored in the same hardware as hardware in which the first root disk image 321 and the second root disk image 322 are stored. In another embodiment of the present disclosure, the base disk image 310 may be stored in hardware disposed remotely separately from hardware in which the first root disk image 321 and the second root disk image 322 are stored, such that the backing process may be performed over a network.

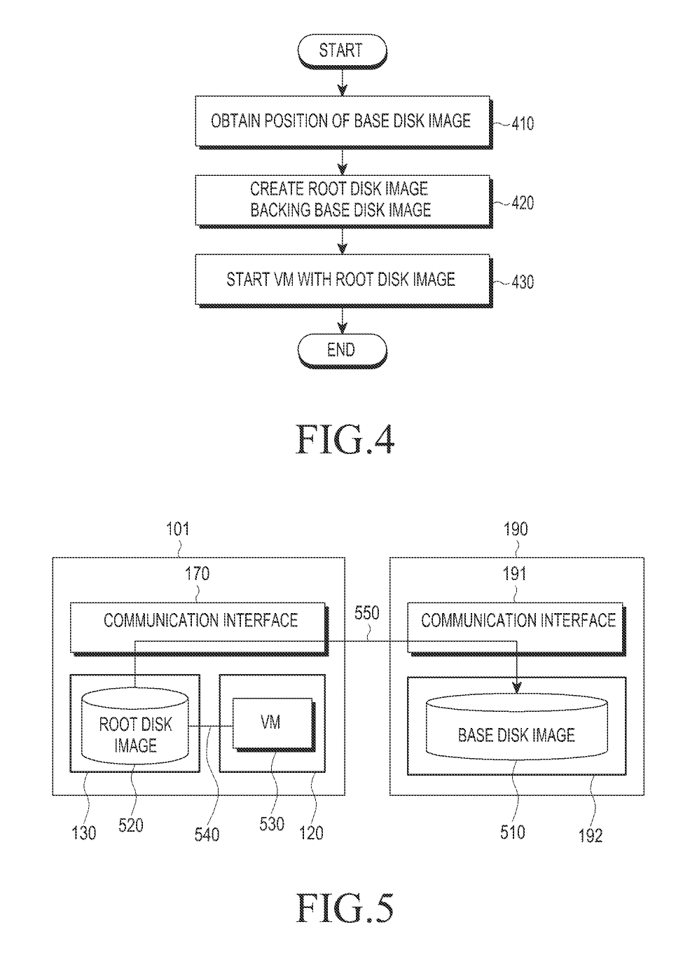

FIG. 4 is a flowchart of a method for executing a VM according to an embodiment of the present disclosure. The embodiment of FIG. 4 will be described below with reference to FIG. 5. FIG. 5 is a diagram illustrating a method for creating a VM according to an embodiment of the present disclosure.

Referring to FIGS. 4 and 5, in operation 410, the electronic device 101 obtains a position of the first base disk image 510 stored in the remote disk image storage 190. In an embodiment of the present disclosure, the electronic device 101 obtains a URL of the first base disk image 510 stored in the disk image storage 190.

In operation 420, the electronic device 101 creates a root disk image 520 that backs the base disk image stored in an external electronic device.

In operation 430, the electronic device 101 executes a VM 530 by using the created root disk image 520. In an embodiment of the present disclosure, the root disk image 520 created by the electronic device 101 may be a write-only disk image, and the first base disk image 510 stored in the external electronic device may be a read-only disk image. The electronic device 101 may process write data input from the VM 530 by using (540) the root disk image 520. For example, the electronic device 101 may store write data input from the VM 530 in the memory 130. The electronic device 101 may process read data input from the VM 530 by using (550) the first base disk image 510. For example, the electronic device 101 may read in read data from the base disk image through the communication interfaces 170 and 191 based on backing information of the root disk image.

In another embodiment of the present disclosure, the root disk image 520 may be a readable/writable disk image. The electronic device 101 may process read data input from the VM 530 by using the root disk image 520. If the read data cannot be processed using the root disk image 520, the electronic device 101 may process the read data by using the first base disk image 510.

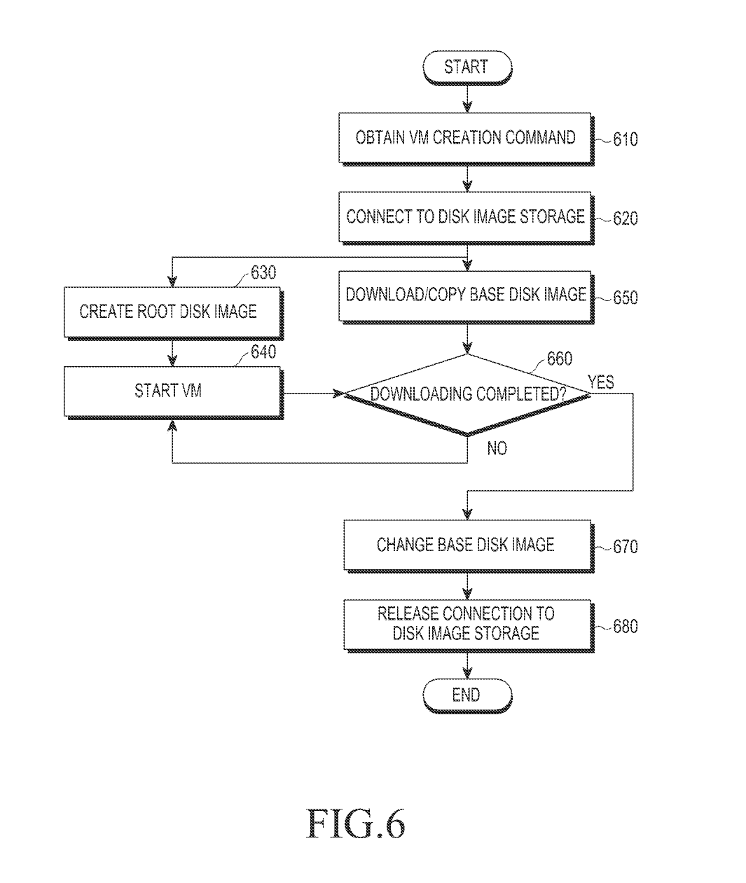

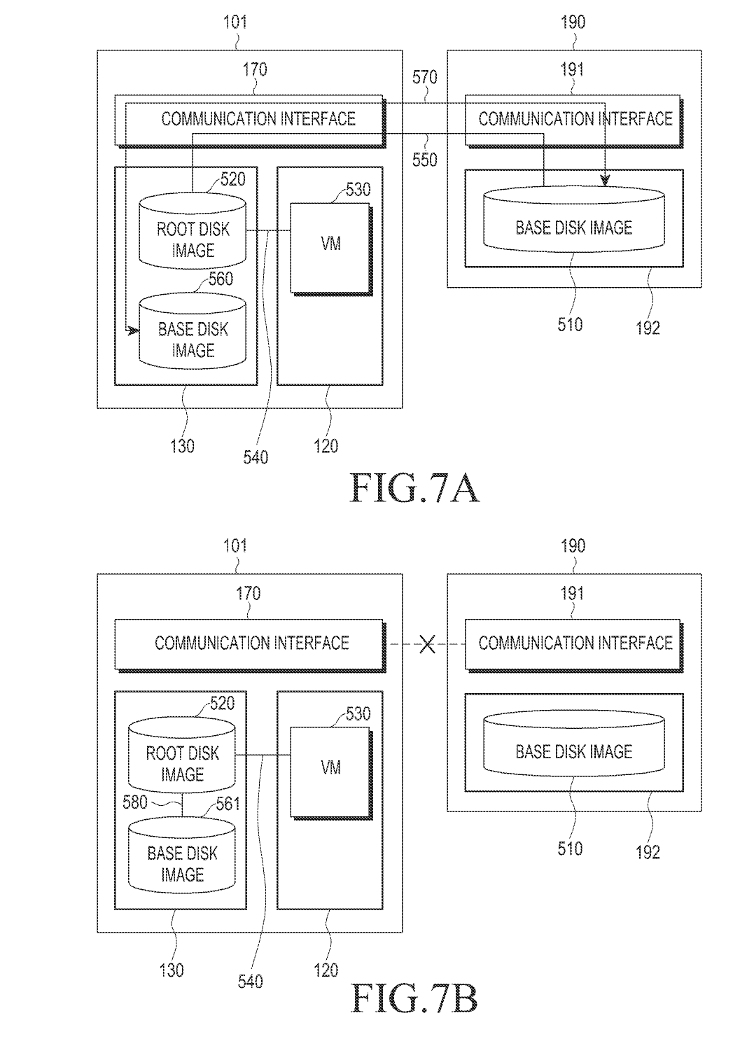

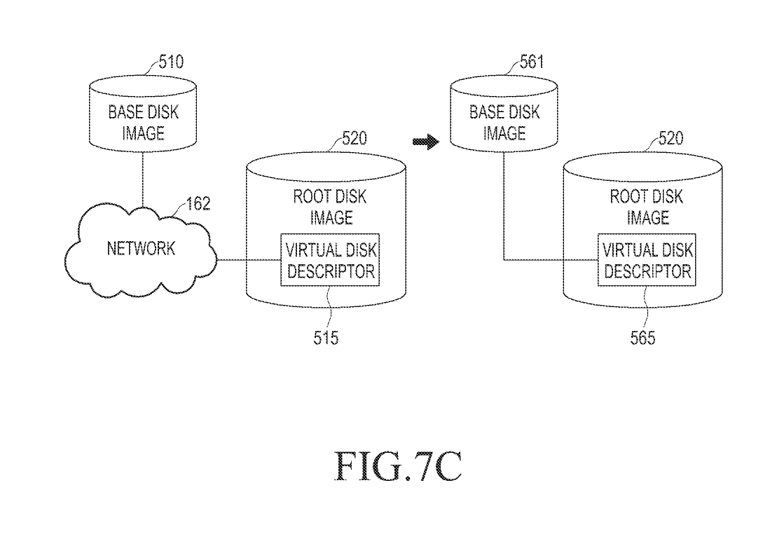

FIG. 6 is a flowchart of a method for executing a VM according to an embodiment of the present disclosure. The embodiment of FIG. 6 will be described below with reference to FIGS. 7A, 7B, and 7C. FIGS. 7A, 7B, and 7C are diagrams illustrating a method for creating a VM according to an embodiment of the present disclosure.

Referring to FIGS. 6, 7A, 7B, and 7C, in operation 610, the electronic device 101 obtains a VM creation command.

In operation 620, the electronic device 101 forms connection to a disk image storage that stores a base disk image corresponding to the VM creation command.

In operation 630, the electronic device 101 creates the root disk image 520 that backs the first base disk image 510 as illustrated in FIG. 7A. In operation 640, the electronic device 101 executes the VM 530 based on the root disk image 520.

In operation 650, the electronic device 101 downloads (570) the first base disk image 510. The electronic device 101 may download (570) the first base disk image 510 in parallel with execution of the VM performed in operations 630 and 640. The electronic device 101 stores a result of the downloading (570) as a second base disk image 560 in the memory 130.

In operation 660, the electronic device 101 determines whether the downloading (570) of the first base disk image 510 is completed. If the downloading (570) of the first base disk image 510 is not completed, the electronic device 101 may maintain execution of the VM based on the root disk image 520 backing the first base disk image 510.

In operation 670, if the downloading (570) of the first base disk image 510 is completed, the electronic device 101 changes a base disk image the root disk image 520 backs into a second base disk image 561. As illustrated in FIG. 7B, the root disk image 520 may back (580) the download-completed second base disk image 561 stored in the memory 130 of the electronic device 101. Thereafter, the VM may be resumed by backing the second base disk image 561. By resuming the VM, the execution of VM may be continued without suspending.

In operation 680, the electronic device 101 releases the formed communication connection with the disk image storage 190. As illustrated in FIG. 7B, communication connection between the communication interfaces 170 and 191 may be released.

In another embodiment of the present disclosure, if the downloading (570) of the first base disk image 510 is completed, the electronic device 101 may merge the download-completed second base disk image 561 and the root disk image 520 to create a merged disk image. The electronic device 101 may execute the VM based on the merged disk image. The electronic device 101 may delete the second base disk image 561 after creating the merged disk image.

FIG. 7C is a diagram illustrating changing of a backing target.

Referring to FIG. 7C, prior to downloading of a base disk image, the root disk image 520 stored in the electronic device 101 may back the first base disk image 510 stored in the remote disk image storage 190 over the network 162. The root disk image 520 stored in the electronic device 101 may exist in the form of a file. For example, a position of the root disk image 520 may be described as “file://<local storage>/disk.img”. Herein, <local storage>may mean the memory 130 in the electronic device 101. The root disk image 520 may be a readable/writable file (for example, “disk.img”), and in another embodiment of the present disclosure, may be a write-only file. The first base disk image 520 may be, for example, a read-only file (for example, “base.img”). For example, for a root disk image in a QCOW2 format, the read-only first base disk image 510 may be referred to as a backing file. A position of the first base disk image 510 may be described as “nfs://<remote storage>/base.img”.

Once the downloading of the base disk image is completed, the root disk image 520 stored in the electronic device 101 may back the download-completed second base disk image 561 stored in the electronic device 101. The second base disk image 561 may be a read-only file (for example, “new base.img”). In another embodiment of the present disclosure, the second base disk image 561 may be a readable/writable file. A storage position of the second base disk image 561 may be, for example, “file://<local storage>/new base.img”. Meanwhile, as illustrated in FIG. 7C, the second base disk image 561 may be backed without using the network 162 because of being stored in the electronic device 101.

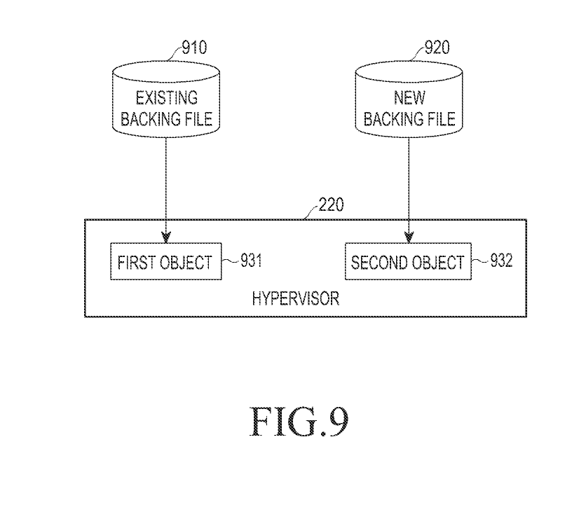

Virtual disk descriptors 515 and 565 are objects containing information about a virtual disk, and control a position of a base disk and an operation (open/close/read/write and so forth) and a state associated with the base disk if the base disk exists. If a base disk image is replaced with another image by a hypervisor 220, contents of the virtual disk descriptors 515 and 565 of a corresponding root disk image are changed. If a position of a backing file is changed by a first object in FIG. 9, the virtual disk descriptor 515 is changed into the virtual disk descriptor 565 and internal information of the virtual disk descriptor 515 is also changed.

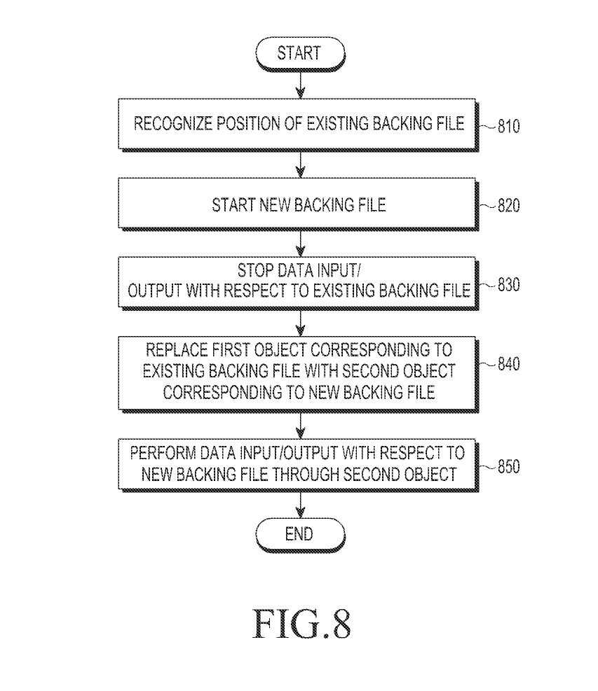

FIG. 8 is a flowchart of a method for changing a backing file according to an embodiment of the present disclosure. The embodiment of FIG. 8 will be described below with reference to FIG. 9. FIG. 9 is a diagram illustrating changing of a backing file according to an embodiment of the present disclosure.

Referring to FIGS. 8 and 9, in operation 810, the hypervisor 220 recognizes a position of an existing backing file 910. The backing file may be a file a root disk image backs. It would be easily understood by those of ordinary skill in the art that “the hypervisor 220 performs an operation” has the same meaning as “the electronic device 101 or the processor 120 of the electronic device 101 performs an operation”. Referring to FIG. 9, the hypervisor 220 controls a first object 931 and a second object 932. Herein, the first object 931 performs data input/output of the existing backing file 910 and the second object 932 performs data input/output of a new backing file 920.

In operation 820, the hypervisor 220 starts the new backing file 920.

In operation 830, the hypervisor 220 stops data input/output with respect to the existing backing file 910. The hypervisor 220 may stop an operation of the first object 931.

In operation 840, the hypervisor 220 changes the first object 931 corresponding to the existing backing file 910 into the second object 932 corresponding to the new backing file 920.

In operation 850, the hypervisor 220 performs data input/output with respect to the new backing file 920 through the second object 932.

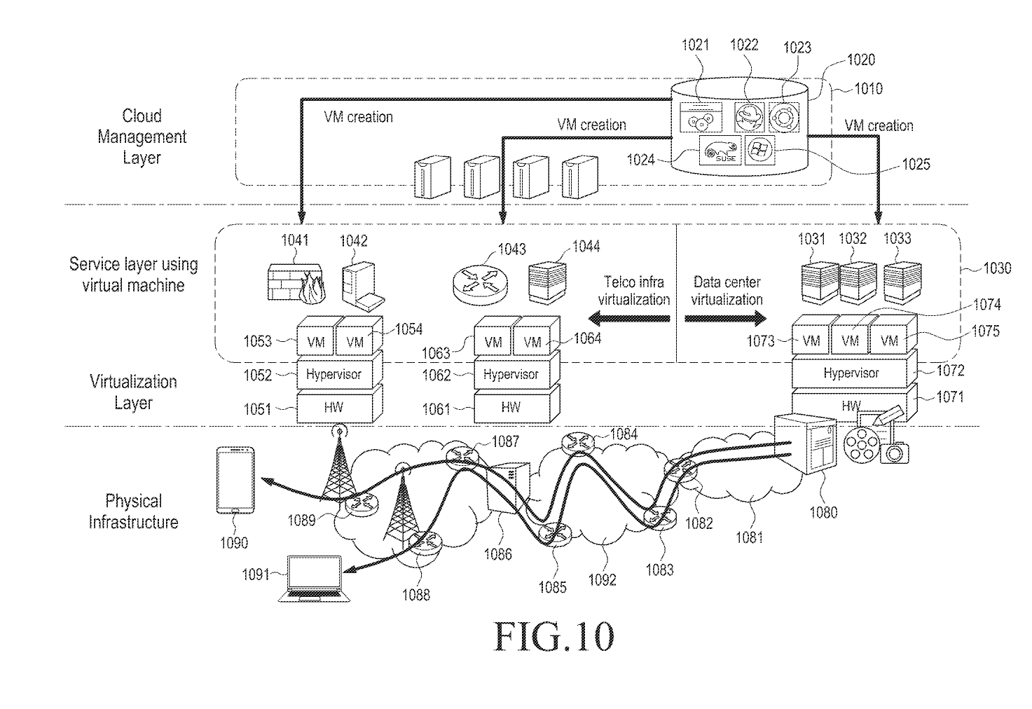

FIG. 10 is a diagram illustrating an execution of a VM in a server according to an embodiment of the present disclosure.

Referring to FIG. 10, a disk image storage 1020 may be included in a cloud management system 1010. The cloud management system 1010 may be defined in a cloud management layer. The disk image storage 1020 may include at least one base disk images 1021 to 1025. The base disk images 1021 to 1025 may be self-contained files including an OS and an application, respectively, and may be, for example, a file corresponding to a firewall, a cache server, and a router. The cloud management system 1010 may include a communication infrastructure, thus forming communication connection of the disk image storage 1020 with another entity in a lower stage, for example, a data center 1030 or a telecommunication (Telco) infra 1040. The cloud management system 1010 selects a hypervisor that is to create a VM and delivers a particular virtual disk image to the hypervisor. Meanwhile, it has been described in an embodiment of the present disclosure that the cloud management system may process and deliver data input/output according to backing by the hypervisor, and thus the cloud management system will not be described further.

In a lower stage of a cloud control layer, a service layer and a virtualization layer using a VM may be defined. In the data center 1030, a data center server may be virtualized such that a data center hardware 1071, a data center hypervisor 1072, and data center VMs 1073 to 1075 may be defined. In the Telco infra 1040, a Telco server may be virtualized such that Telco infra hardware 1051 and 1061, Telco infra hypervisors 1052 and 1062, and Telco infra VMs 1053, 1054, 1063, and 1064 may be defined. For example, the data center hypervisor 1072 may operate the data center VMs 1073 to 1075 by combining a disk image with a virtual CPU, a virtual memory, and a virtual network. The VM 1053 may be associated with a firewall 1041, the VM 1054 may be associated with a cache server 1042, the VM 1063 may be associated with a router 1043, the VM 1064 may be associated with a media server 1044, and the VMs 1073, 1074, and 1075 may be associated with web server and data base (DB) server 1031, 1032, and 1033. For example, the data center hypervisor 1072 may operate the data center VMs 1073 to 1075 by combining a disk image with a virtual CPU, a virtual memory, and a virtual network.

In a lower stage of a virtualization layer, a physical infra may be defined. The physical infra may include hardware 1080 of a disk image storage and electronic devices 1090 and 1091. Moreover, the physical infra may include Internet 1081 for data transmission and reception, routers 1082, 1083, 1084, 1085, and 1087, access points (APs) 1088 and 1089, and a backbone network 1092. The electronic devices 1090 and 1091 may download a disk image from the hardware 1080 of the disk image storage through at least one of the Internet 1081, the routers 1082, 1083, 1084, 1085, and 1087, the APs 1088 and 1089, and the backbone network 1092. Alternatively, the electronic devices 1090 and 1091 may back the disk image stored in the hardware 1080 of the disk image storage through at least one of the routers 1082, 1083, 1084, 1085, and 1087, the APs 1088 and 1089, and the backbone network 1092. The electronic devices 1090 and 1091 may communicate with a Telco server or a data center 1086.

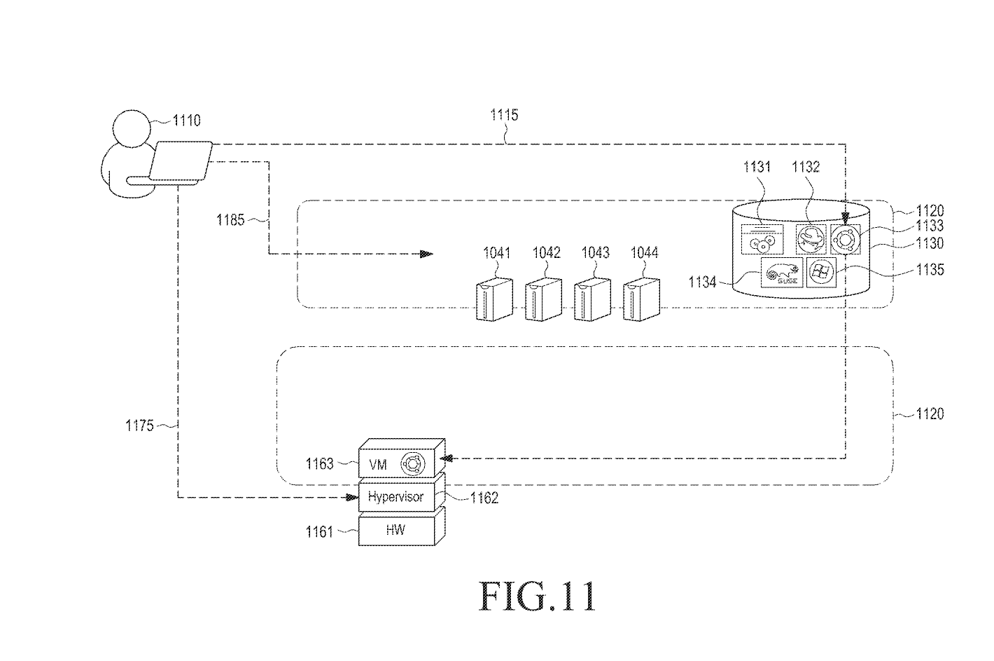

FIG. 11 is a diagram illustrating creation of a streaming service according to an embodiment of the present disclosure.

Referring to FIG. 11, a disk image storage 1130 may be included in a cloud management system 1120. The disk image storage 1130 may store at least one disk images 1131 through 1135. More particularly, the disk image storage 1130 may store a streaming-service-related disk image 1133.

The cloud management system 1120 may be defined in a cloud management layer. The cloud management system 1120 may include at least one cloud servers 1041 through 1044.

The embodiment of FIG. 11 may concern a scenario in which a user 1110 (or a manager) virtualizes a streaming service server in a base station server ENB. The base station server ENB may be, for example, a server for performing wireless communication with an electronic device.

The user 1110 may select (1115) a virtualization target disk image, for example, the streaming-service-related disk image 1133. The streaming-service-related disk image 1133 may include, for example, a first OS and a streaming service application. The first OS may be an OS capable of driving a streaming service application.

If the streaming-service-related disk image 1133 is selected, the user 1110 may further select (1175) a hypervisor 1162 in which a streaming service VM is to be installed. The user 1110 may send a streaming service VM creation command 1185.

The hypervisor 1162 creates and executes a streaming service VM 1163 and distributes resources of hardware 1161 to the streaming service VM 1163. The hypervisor 1162 creates a root disk image that backs the streaming-service-related disk image 1133, and executes the streaming service VM 1163 based on the created root disk image.

As the hypervisor 1162 executes the streaming service VM 1163, the base station server ENB may provide a streaming service. Moreover, the hypervisor 1162 downloads the streaming-service-related disk image 1133 in parallel, and upon completing the downloading, changes a backing target for the root disk image into the downloaded disk image.

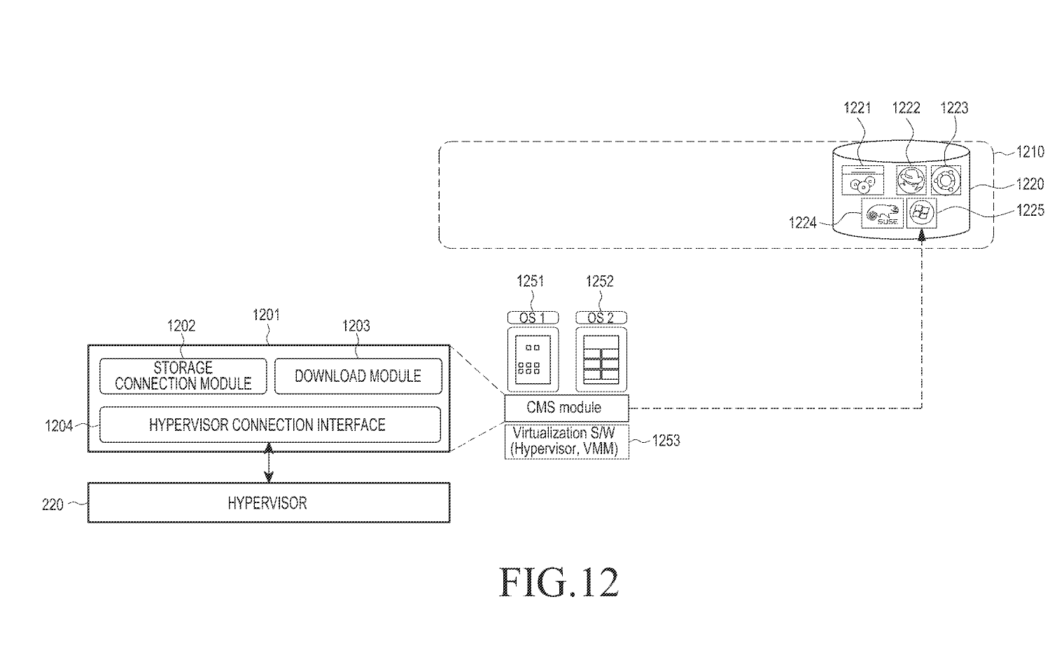

FIG. 12 is a diagram illustrating an execution of a VM in a terminal device according to an embodiment of the present disclosure.

Referring to FIG. 12, a disk image storage 1220 may be included in a cloud management system 1210. The disk image storage 1220 may store at least one disk images 1221 to 1225. More particularly, the disk image storage 1220 may store a second OS-related disk image 1225.

In the terminal device, the hypervisor 220 may be defined. In an upper stage of the hypervisor 220, a cloud management system module 1201 may be defined. For example, the terminal device may execute a VM through the cloud management system module 1201 defined therein without being controlled by the cloud management system 1210.

In an embodiment of the present disclosure, the cloud management system module 1201 may include a storage connection module 1202, a download module 1203, and a hypervisor connection interface 1204. The cloud management system module 1201 may operate on virtualization software 1253.

The storage connection module 1202 may, for example, form communication connection with a remote disk image storage through an NFS protocol. The storage connection module 1202 may, for example, perform data input/output with respect to a base disk image that a root disk image created in the terminal device backs.

The download module 1203 downloads a base disk image from the remote disk image storage.

The hypervisor connection interface 1204 performs data input/output between the management system module 1201 and the hypervisor 220.

The terminal device is assumed to be executed based on a first OS 1251. Meanwhile, the user may desire change from the first OS 1251 to a second OS 1252. The user may select a second OS-related disk image 1225.

The hypervisor 220 creates a root disk image to control the root disk image to back the second OS-related disk image 1225 through the storage connection module 1202. The hypervisor 220 controls downloading of a base disk image through the download module 1230. Once the downloading is completed, the hypervisor 220 may change a backing target for the root disk image into the base disk image downloaded from the remote disk image storage.

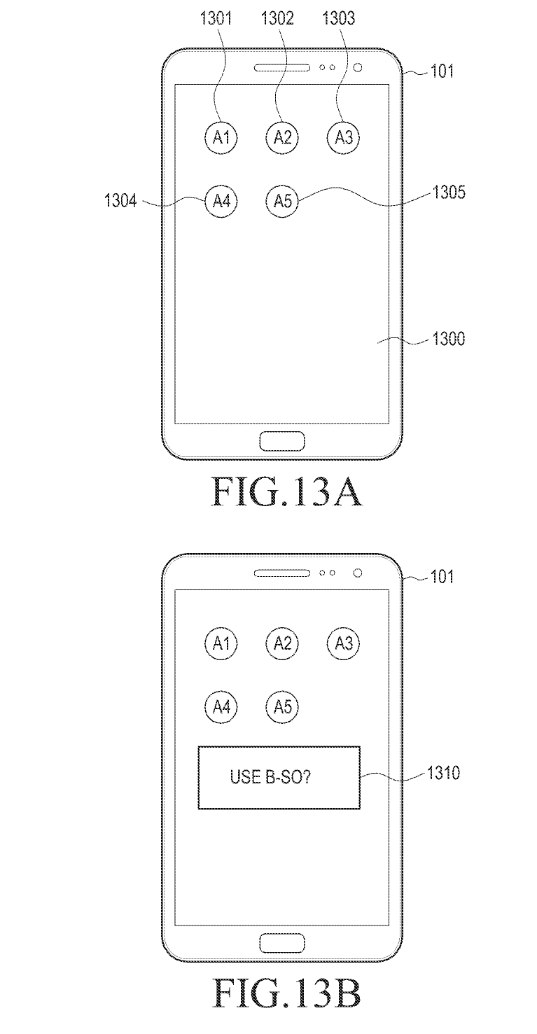

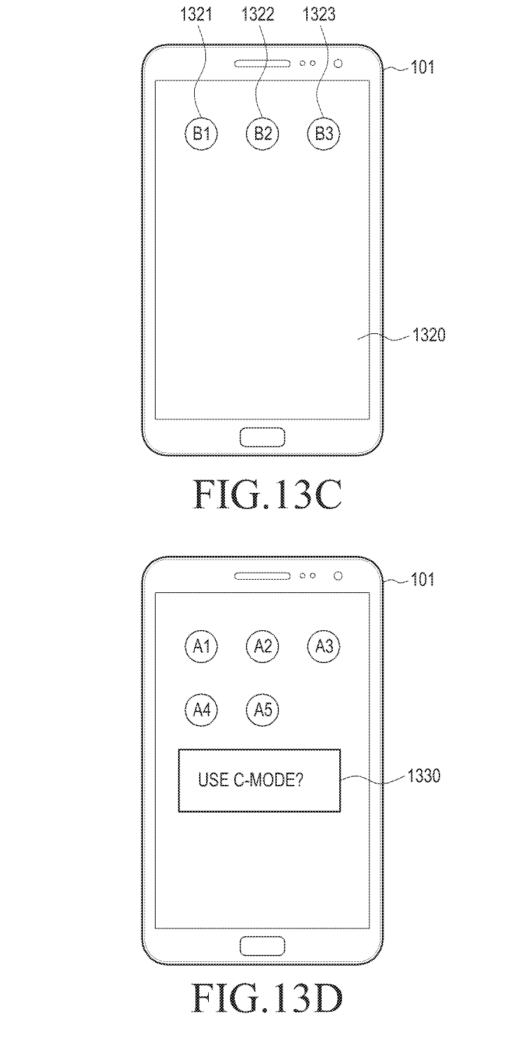

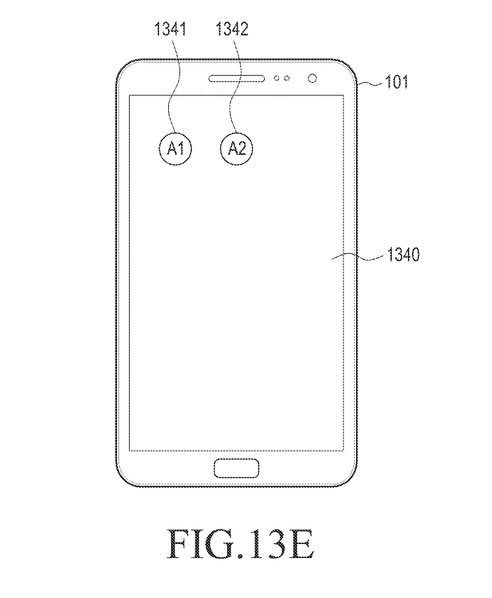

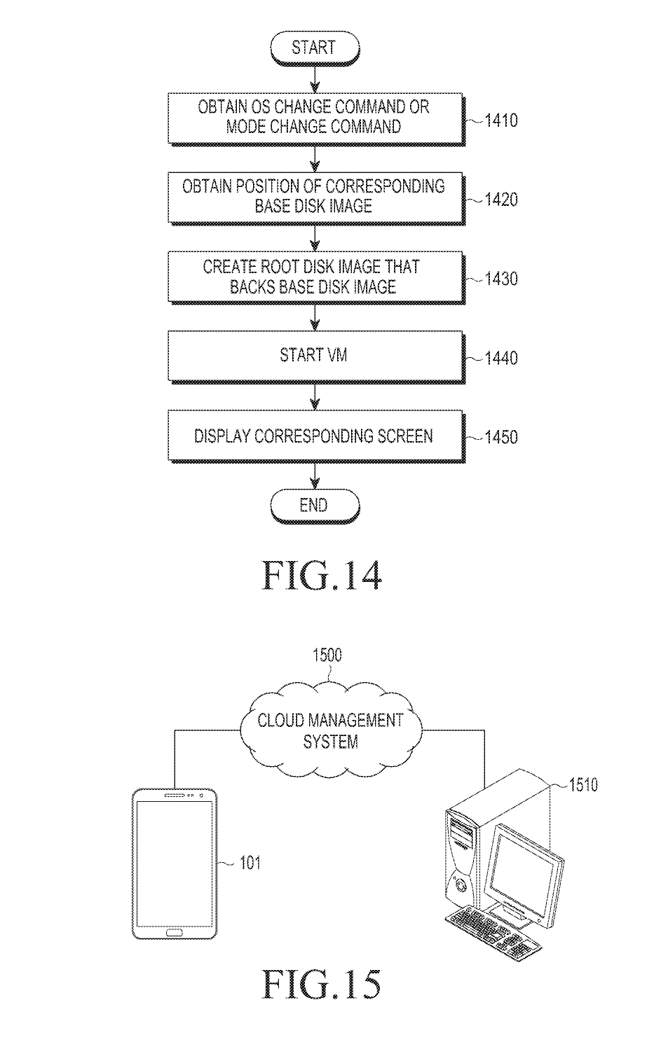

FIGS. 13A, 13B, 13C, 13D, and 13E are diagrams illustrating a screen configuration of an electronic device according to an embodiment of the present disclosure. FIGS. 13A, 13B, 13C, 13D, and 13E will be described below with reference to FIG. 14. FIG. 14 is a flowchart of a method for controlling an electronic device according to an embodiment of the present disclosure.

Referring to FIGS. 13A, 13B, 13C, 13D, 13E, and 14, in operation 1410, the electronic device 101 obtains an OS change command or a mode change command. For example, as illustrated in FIG. 13A, the electronic device 101 displays a screen 1300 based on a first OS A. The screen 1300 based on the first OS may be, for example, a menu screen and may include at least one executable application icons 1301 to 1305. Referring to FIG. 13B, the electronic device 101 may obtain an OS change command from the first OS A to a second OS B. For example, the electronic device 101 may display a graphic user interface 1310 inquiring the OS change command and obtain a choice to obtain the OS change command. Meanwhile, an OS and a mode may be collectively referred to as an environment.

In operation 1420, the electronic device 101 obtains a position of a corresponding base disk image. For example, the electronic device 101 may obtain a position of the base disk image corresponding to the second OS B. Herein, the base disk image corresponding to the second OS B may be stored in a remote disk image storage. In an embodiment of the present disclosure, the electronic device 101 may obtain a URL of the base disk image.

In operation 1430, the electronic device 101 creates a root disk image that backs the base disk image based on the obtained position. In an embodiment of the present disclosure, the root disk image may be a write-only disk image.

In operation 1440, the electronic device 101 starts a VM based on the root disk image. In operation 1450, the electronic device 101 displays a corresponding screen. For example, as illustrated in FIG. 13C, the electronic device 101 may include a corresponding screen 1320 corresponding to the second OS B. The corresponding screen 1320 may include at least one application icons 1321 to 1323 operating in the second OS B. The at least one application icons 1321 to 1323 may be included together in the base disk image.

As mentioned above, the electronic device 101 may operate by changing the OS from the first OS A to the second OS B. The electronic device 101 may execute a VM in such a way that the root disk image backs the base disk image remotely, without downloading the entire base disk image corresponding to the second OS B, thereby rapidly changing the OS. More particularly, if the electronic device 101 is a terminal device, such as a smartphone, downloading of the entire base disk image may be difficult to perform, such that the aforementioned OS change method may provide more robust effects.

In another embodiment of the present disclosure, the electronic device 101 may obtain a mode change command as illustrated in FIG. 13D. For example, the electronic device 101 displays a graphic user interface 1330 inquiring the mode change command and obtains a choice to obtain the mode change command. Herein, the mode may mean a set of applications executable in a particular OS. For example, in FIG. 13A, the screen 1300 may correspond to a first mode in the first OS A. The first mode may include the first application icon 1301 through the fifth application icon 1305. As illustrated in FIG. 13E, a second mode C may include a first application icon 1341 and a second application icon 1342 that are executable in the first OS A displayed a screen 1340. For example, the mode may be preset based on the purpose of use. In an embodiment of the present disclosure, in the first mode, the first application icon 1301 through the fifth application icon 1305 may be set based on a general use purpose. In the second mode, the first application icon 1301 and the second application icon 1302 may be set based on a business use purpose. Meanwhile, it would be easily understood by those of ordinary skill in the art that the second mode may also include other application icons that are not stored in the first mode.

FIG. 15 is a diagram illustrating a process of executing a VM according to an embodiment of the present disclosure.

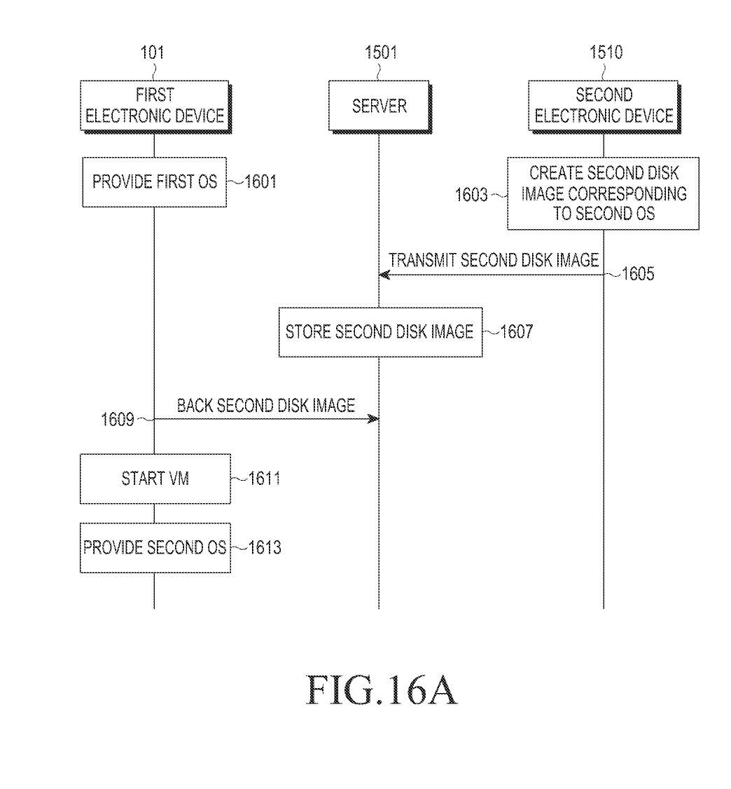

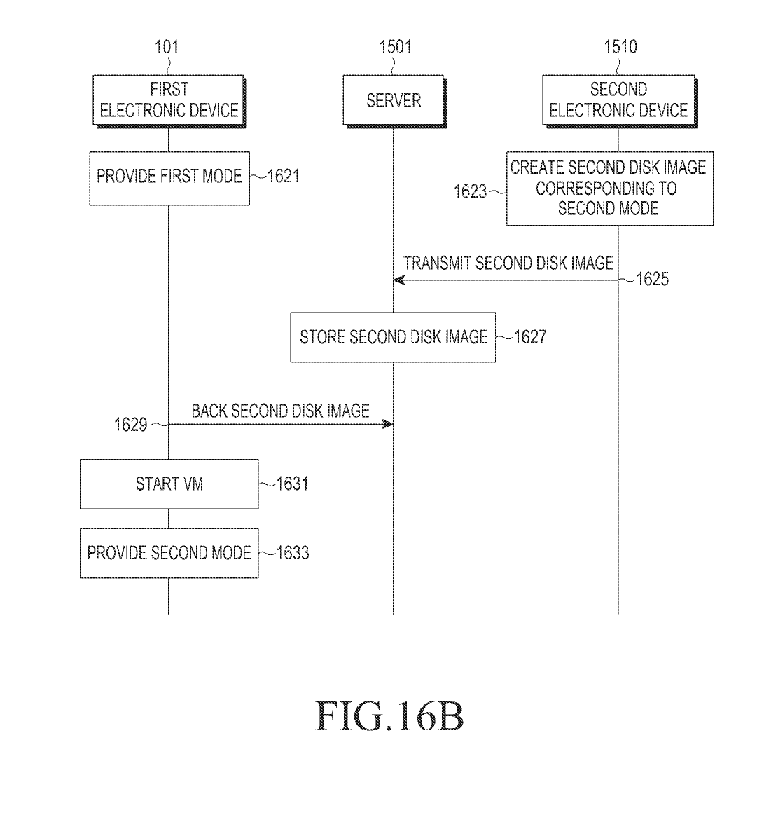

Referring to FIG. 15, the electronic device 101 is assumed to be a terminal device and for convenience, may be referred to as the first electronic device 101. The embodiment of FIG. 15 will be described below with reference to FIGS. 16A and 16B.

FIGS. 16A and 16B are flowcharts of a process of executing a VM according to an embodiment of the present disclosure.

Referring to FIG. 15, the first electronic device 101 may be connected with another terminal device, for example, a second electronic device 1510, through a cloud management system 1500. The cloud management system 1500 may include at least one servers.

Referring to FIG. 16A, in operation 1601, the first electronic device 101 may provide the first OS. For example, the first electronic device 101 may provide an application execution environment based on the first OS.

In operation 1603, the second electronic device 1510 creates a second disk image corresponding to the second OS. The second disk image may include the second OS and at least one applications executable in the second OS. The second electronic device 1510 may create the second disk image based on a creation command input from outside or may create the second disk image if a preset event is detected.

In operation 1605, the second electronic device 1510 transmits the created second disk image to a server 1501 included in the cloud management system 1500.

In operation 1607, the server 1501 stores the second disk image received from the second electronic device 1510.

In operation 1609, the first electronic device 101 creates a root disk image and controls the root disk image to back the second disk image stored in the server 1501.

In operation 1611, the first electronic device 101 starts and executes the VM based on the root disk image. In operation 1613, the first electronic device 101 provides the second OS and thus executes an application executed in the second electronic device 1510.

Referring to FIG. 16B, in operation 1621, the first electronic device 101 provides a first mode. For example, the first electronic device 101 may provide a first application executable in a first OS in the first mode.

In operation 1623, the second electronic device 1510 creates the second disk image corresponding to the second mode. The second disk image may include the first OS and the second application executable in the first OS. The second electronic device 1510 may create the second disk image based on a creation command input from outside or may create the second disk image if a preset event is detected.

In operation 1625, the second electronic device 1510 transmits the created second disk image to the server 1501 included in the cloud management system 1500.

In operation 1627, the server 1501 stores the second disk image received from the second electronic device 1510.

In operation 1629, the first electronic device 101 creates the root disk image and controls the root disk image to back the second disk image stored in the server 1501.

In operation 1631, the first electronic device 101 starts and executes the VM based on the root disk image. In operation 1633, the first electronic device 101 provides a second application executable in the first OS and thus executes the second application executed in the second electronic device 1510.

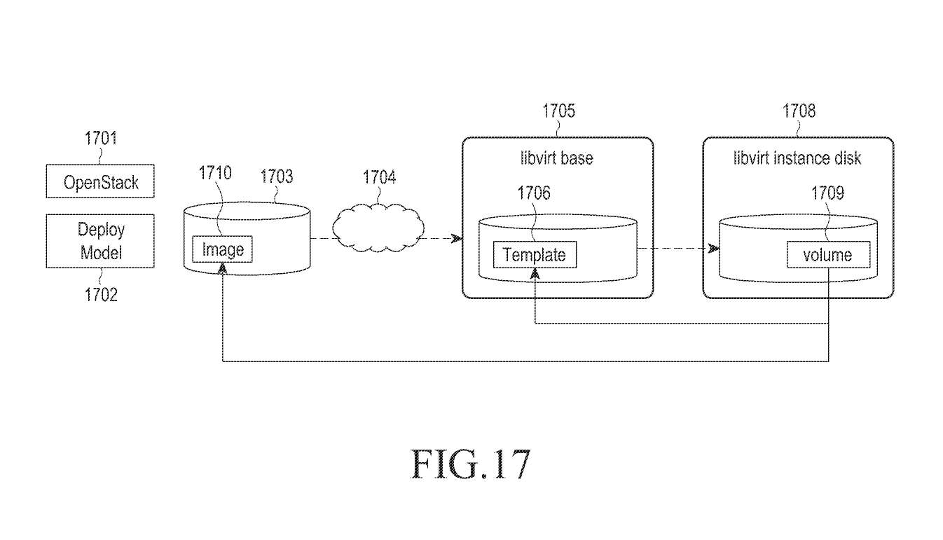

FIG. 17 is a diagram illustrating a process of executing a VM according to an embodiment of the present disclosure. In FIG. 17, a method for executing a VM in an open stack system will be described.

Referring to FIG. 17, the method for executing a VM may be executed in an open stack 1701 system. The open stack 1701 may be an open source clouding computing platform.

A base disk image 1710 may be stored in, for example, a glance, such as a network file system (NFS) store. The base disk image 1710 may be downloaded and stored in a libvirt base disk image storage 1705 over a network 1704. A downloaded base disk image 1706 may be, for example, a template file having the same contents as the base disk image 1710. Based on a deploy model 1702, libvirt, which is an open source API, may provide a management tool for management of various virtualization platforms, such as KVM, XEN, Vmware, and the like. Meanwhile, in a libvirt temporary disk storage 1708, a root disk image 1709 may be created with a certain volume and may back the base disk image 1710 in a glance 1703. The VM is executed using the root disk image 1709 created using the glance 1703, and if downloading of the template image 1706 in which the base disk image 1706 is downloaded is completed, the base disk image 1710 may be changed into the template image 1706 through a libvirt API.

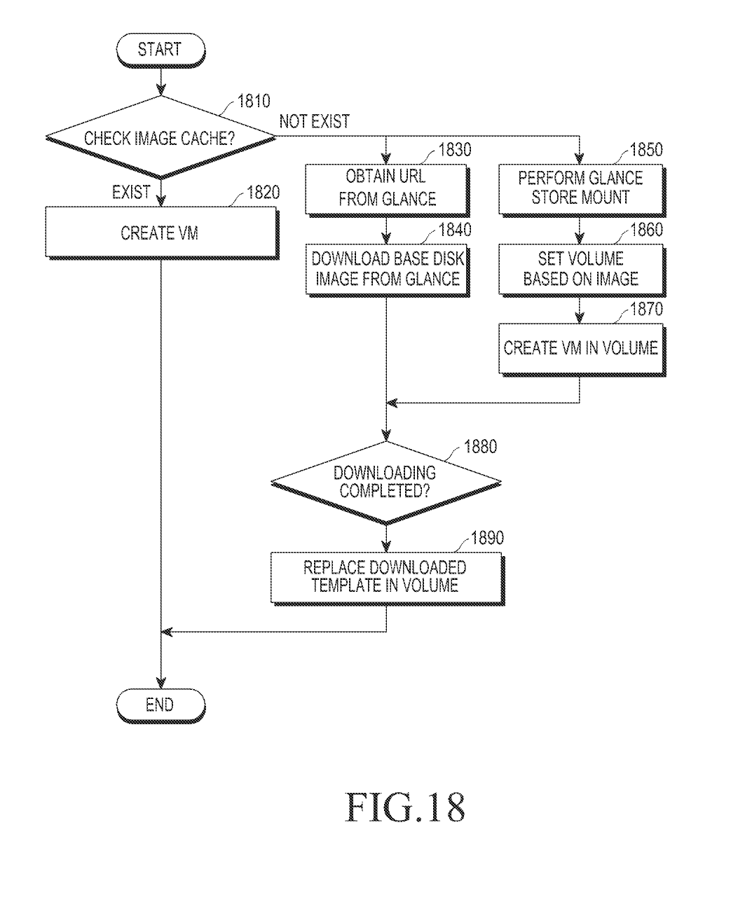

FIG. 18 is a flowchart of a method for executing a VM according to an embodiment of the present disclosure.

Referring to FIG. 18, in operation 1810, the electronic device 101 checks an image cache. More specifically, the electronic device 101 may determine whether a particular disk image capable of executing a VM exists in the electronic device 101.

In operation 1820, if determining that the particular disk image exists, the electronic device 101 creates and executes the VM based on the particular disk image.

In operation 1830, if determining that the particular disk image does not exist, the electronic device 101 obtains a URL of a corresponding base disk image from the glance 1703.

In operation 1840, the electronic device 101 downloads the base disk image from the glance 1703.

In operation 1850, the electronic device 101 performs NFS mount with respect to the glance 1703. More specifically, the electronic device 101 may form communication connection to the glance 1703 by using a protocol, such as an NFS.

In operation 1860, the electronic device 101 sets a root disk image and a volume for executing a VM based on the NFS-mounted base disk image.

In operation 1870, the electronic device 101 creates the VM in the set volume and may create and execute the VM based on the root disk image.

In operation 1880, the electronic device 101 determines whether the downloading is completed. If the downloading of the base disk image is completed, the electronic device 101 replaces the downloaded template-form base disk image in the set volume in operation 1890. More specifically, the electronic device 101 may change a backing target for the root disk image into the downloaded-template-form base disk image.

According to an embodiment of the present disclosure, a method for executing a VM in an electronic device includes obtaining a position of a first base disk image stored in a disk image storage, creating a root disk image that backs the first base disk image based on the obtained position, and executing the VM based on the created root disk image.

According to an embodiment of the present disclosure, the method may further include downloading the first base disk image from the disk image storage and storing a second base disk image in the electronic device.

According to an embodiment of the present disclosure, the method may further include controlling the root disk image to back the second base disk image if the downloading of the first base disk image is completed.

According to an embodiment of the present disclosure, the controlling of the root disk image to back the second base disk image may include changing an object that performs data input/output from a first object corresponding to the first base disk image to a second object corresponding to the second base disk image.

According to an embodiment of the present disclosure, the method may further include stopping data input/output from the first object and starting data input/output from the second object if the changing to the second object is completed.

According to an embodiment of the present disclosure, the method may further include creating a merged disk image by merging the root disk image and the second base disk image, if the downloading of the first base disk image is completed, and executing the VM based on the created merged disk image.

According to an embodiment of the present disclosure, the method may further include deleting the second base disk image.

According to an embodiment of the present disclosure, the method may further include releasing connection with the disk image storage if the downloading of the first base disk image is completed.

According to an embodiment of the present disclosure, the obtaining of the position of the first base disk image stored in the disk image storage may include obtaining a URL of the first base disk image.

According to an embodiment of the present disclosure, an electronic device for executing a VM in an electronic device includes a communication interface configured to form communication connection with a disk image storage that stores a first base disk image and a processor configured to obtain a position of a first base disk image stored in a disk image storage, to create a root disk image that backs the first base disk image based on the obtained position, and to execute the VM based on the created root disk image.

According to an embodiment of the present disclosure, the electronic device may further include a memory, in which the communication interface downloads the first base disk image from the disk image storage and stores a second base disk image in the electronic device.

According to an embodiment of the present disclosure, the processor may control the root disk image to back the second base disk image if the downloading of the first base disk image is completed.

According to an embodiment of the present disclosure, the processor may change an object that performs data input/output from a first object corresponding to the first base disk image to a second object corresponding to the second base disk image.

According to an embodiment of the present disclosure, the processor may stop data input/output from the first object and start data input/output from the second object if the changing to the second object is completed.

According to an embodiment of the present disclosure, the processor may create a merged disk image by merging the root disk image and the second base disk image, if the downloading of the first base disk image is completed, and execute the VM based on the created merged disk image.

According to an embodiment of the present disclosure, the processor may delete the second base disk image.

According to an embodiment of the present disclosure, the processor may release connection with the disk image storage if the downloading of the first base disk image is completed.

According to an embodiment of the present disclosure, the processor may obtain a URL of the first base disk image to back the first base disk image based on the obtained URL.

According to an embodiment of the present disclosure, a method for executing a VM in an electronic device includes executing the VM based on a root disk image that backs a first base disk image stored outside the electronic device, changing a backing target for the root disk image from the first base disk image to a second base disk image stored inside the electronic device, and executing the VM based on the root disk image that backs the second base disk image.

According to an embodiment of the present disclosure, the changing of the backing target may include changing an object that performs data input/output from a first object corresponding to the first base disk image to a second object corresponding to the second base disk image.

According to an embodiment of the present disclosure, an electronic device for executing a VM includes a communication interface configured to back a first base disk image stored outside the electronic device and a processor configured to execute the VM based on a root disk image that backs the first base disk image, in which the processor changes the backing target for the root disk image from the first base disk image to a second base disk image stored inside the electronic device, and executes the VM based on the root disk image that backs the second base disk image.

According to an embodiment of the present disclosure, the processor may change an object that performs data input/output from a first object corresponding to the first base disk image to a second object corresponding to the second base disk image.

According to an embodiment of the present disclosure, a method for executing a VM in an electronic device includes executing the VM based on a root disk image that backs a first base disk image stored outside the electronic device, downloading the first base disk image and storing a second base disk image inside the electronic device, merging the root disk image and the second base disk image to create a merged disk image, if the downloading of the first base disk image is completed, and executing the VM based on the created merged disk image.

According to an embodiment of the present disclosure, a method for executing a VM in an electronic device includes executing the VM based on a root disk image that backs a first base disk image stored outside the electronic device, downloading the first base disk image and storing a second base disk image inside the electronic device, merging the root disk image and the second base disk image to create a merged disk image, if the downloading of the first base disk image is completed, and executing the VM based on the created merged disk image.

According to an embodiment of the present disclosure, an electronic device for executing a VM includes a communication interface configured to back a first base disk image stored outside the electronic device, a processor configured to execute the VM based on a root disk image that backs the first base disk image, and a memory configured to download the first base disk image and to store a second base disk image, in which the processor merges the root disk image and the second base disk image to create a merged disk image, if the downloading is completed, and executes the VM based on the created merged disk image.

According to an embodiment of the present disclosure, the root disk image is a write-only disk image.

According to an embodiment of the present disclosure, a method for configuring a screen of an electronic device includes displaying a first screen based on a first environment, obtaining an environment change command requesting change from the first environment to a second environment, obtaining a position of a base disk image corresponding to the second environment, creating a root disk image that backs the base disk image, and displaying a second screen based on the second environment by executing a VM based on the root disk image.

According to an embodiment of the present disclosure, the first environment may be related to a first OS or a first mode, and the second environment may be related to a second OS or a second mode.

According to an embodiment of the present disclosure, an electronic device includes a display configured to display a first screen based on a first environment, an input/output interface configured to obtain an environment change command requesting change from the first environment to a second environment, and a processor configured to obtain a position of a base disk image corresponding to the second environment, to create a root disk image that backs the base disk image, and to display a second screen based on the second environment by executing a VM based on the root disk image.

According to an embodiment of the present disclosure, the first environment may be related to a first OS or a first mode, and the second environment may be related to a second OS or a second mode.

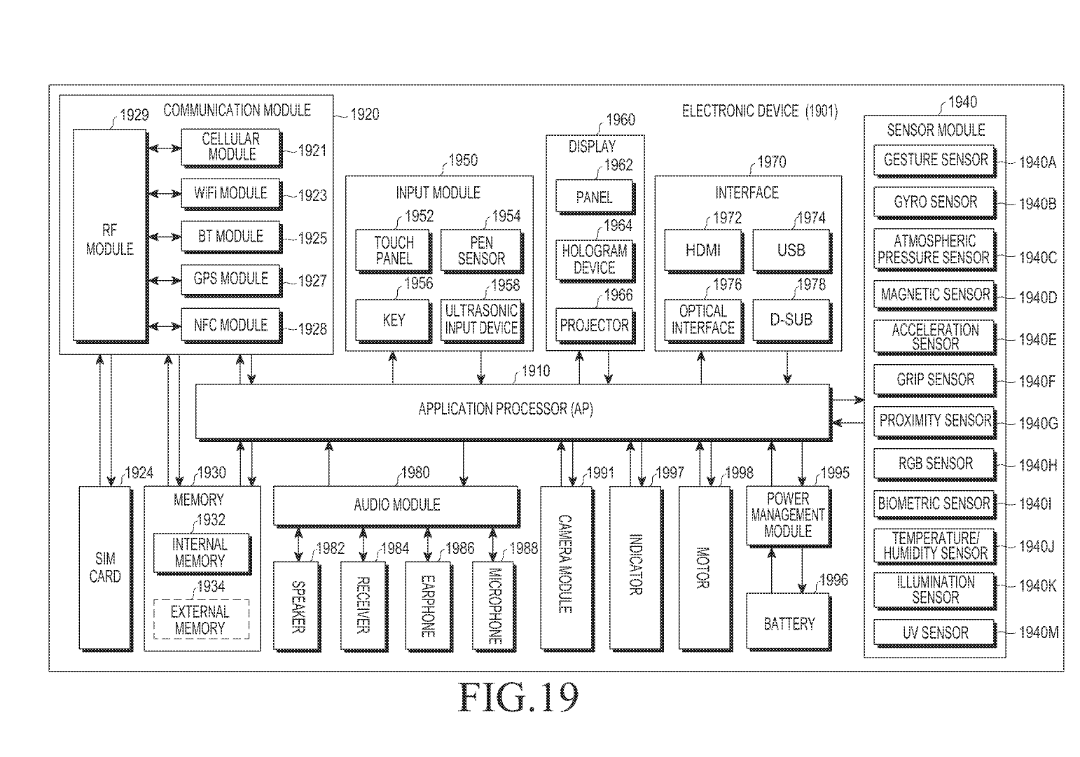

FIG. 19 is a block diagram of an electronic device according to an embodiment of the present disclosure. FIG. 19 may be a block diagram where the electronic device is implemented with a terminal device.

Referring to FIG. 19, an electronic device 1901 may include, for example, the entire electronic device 101 or some elements thereof The electronic device 1901 may include a whole or a part of, for example, the electronic device 101 illustrated in FIG. 1. The electronic device 1901 may include one or more APs 1910, a communication module 1920, a subscriber identification module (SIM) card 1924, a memory 1930, a sensor module 1940, an input device 1950, a display 1960, an interface 1970, an audio module 1980, a camera module 1991, a power management module 1995, a battery 1996, an indicator 1997, and a motor 1998.

The AP 1910 controls multiple hardware or software elements connected to the AP 810 or performs various data processing or operations, for example, by driving an OS or an application program. The AP 1910 may be implemented, for example, with a system on chip (SoC). According to an embodiment of the present disclosure, the AP 1910 may further include a graphic processing unit (GPU) and/or an image signal processor (ISP). The AP 1910 may include, for example, a cellular module. The AP 1910 loads a command or data received from at least one of other elements (for example, a nonvolatile memory) into a volatile memory to process the command or data, and stores various data in the nonvolatile memory.

The communication module 1920 may have a configuration that is the same as or similar to that of the communication interface 170 of FIG. 1B. The communication module 1920 may include, for example, a cellular module 1921, a wireless fidelity (Wi-Fi) module 1923, a bluetooth (BT) module 1925, a GPS module 1927, a near field communication (NFC) module 1928, and a radio frequency (RF) module 1929.

The cellular module 1921 provides voice communication, video communication, a text service, or an Internet service over a communication network. According to one embodiment of the present disclosure, the cellular module 1921 performs identification and authentication with respect to the electronic device 1901 in a communication network by using a SIM (for example, the SIM card 1924). According to an embodiment of the present disclosure, the cellular module 1921 may perform at least some of functions that may be provided by the AP 1910. According to an embodiment of the present disclosure, the cellular module 1921 may include a CR

Each of the Wi-Fi module 1923, the BT module 1925, the GPS module 1927, and the NFC module 1928 may include a processor for processing data transmitted and received therethrough. According to some embodiments of the present disclosure, at least some (for example, two or more) of the cellular module 1921, the Wi-Fi module 1923, the BT module 1925, the GPS module 1927, and the NFC module 1928 may be integrated into a single integrated chip (IC) or IC package.

The RF module 1929 transmits and receives, for example, a communication signal (for example, an RF signal). The RF module 1929 may include, for example, a transceiver, a power amp module (PAM), a frequency filter, a low noise amplifier (LNA), or an antenna. According to another embodiment of the present disclosure, at least one of the cellular module 1921, the Wi-Fi module 1923, the BT module 1925, the GPS module 1927, and the NFC module 1928 transmits and receives an RF signal through the separate RF module 1929.

The SIM card 1924 may include, for example, a card including an SIM and/or an embedded SIM, and may include unique identification information (for example, an integrated circuit card identifier (ICCID)) or subscriber information (for example, an international mobile subscriber identity (IMSI)).

The memory 1930 (for example, the memory 130) may include, for example, an internal memory 1932 or an external memory 1934. The embedded memory 1932 may include, for example, at least one of a volatile memory (for example, a dynamic random access memory (DRAM) or synchronous dynamic RAM (SDRAM)), a nonvolatile memory (for example, an one time programmable read only memory (OTPROM), a programmable ROM (PROM), an erasable and programmable ROM (EPROM), an electrically erasable and programmable ROM (EEPROM), a mask ROM, a flash ROM), or a flash memory, such as a not and (NAND) flash or a not or (NOR) flash, a hard drive, and a solid state drive (SSD).

The external memory 1934 may further include a flash drive, for example, a compact flash (CF), a secure digital (SD), a micro-SD, a mini-SD, an extreme digital (xD), or a memory stick. The external memory 1934 may be functionally and/or physically connected with the electronic device 1901 through various interfaces.

The sensor module 1940 measures a physical amount or detects an operation status of the electronic device 1901 to convert the measured or detected information into an electric signal. The sensor module 1940 may include, for example, at least one of a gesture sensor 1940A, a gyro sensor 1940B, an atmospheric pressure sensor 1940C, a magnetic sensor 1940D, an acceleration sensor 1940E, a grip sensor 1940F, a proximity sensor 1940G, a color sensor 1940H (for example, a red, green, blue (RGB) sensor), a biometric sensor 19401, a temperature/humidity sensor 1940J, an illumination sensor 1940K, and an ultraviolet (UV) sensor 1940M. Additionally or alternatively, the sensor module 1940 may further include an E-nose sensor, an electromyography (EMG) sensor, an electro encephalo gram (EEG) sensor, an electro cardio gram (ECG) sensor, an infrared (IR) sensor, an iris sensor, and/or a fingerprint sensor. The sensor module 1940 may further include a control circuit for controlling at least one sensors included therein. In some embodiments of the present disclosure, the electronic device 1901 may further include a processor configured to control the sensor module 1940 as a part of or separately from the AP 1910, to control the sensor module 1940 when the AP 1910 is in a sleep status.

The input device 1950 may include, for example, a touch panel 1952, a (digital) pen sensor 1954, a key 1956, or an ultrasonic input device 1958. The touch panel 1952 may use, for example, at least one of a capacitive type, a resistive type, an IR type, and an ultrasonic type. The touch panel 1952 may further include a control circuit. The touch panel 1952 may further include a tactile layer to provide tactile reaction to a user.

The (digital) pen sensor 1954 may be, for example, a part of the touch panel or a separate recognition sheet. The key 1956 may include, for example, a physical button, an optical key, or a keypad. The ultrasonic input device 1958 may detect audio waves and check data through a microphone (MIC) (for example, a MIC 1988) in the electronic device 1901 through an input device for generating an ultrasonic signal.

The display 1960 (for example, the display 160) may include a panel 1962, a hologram device 1964, or a projector 1966. The panel 1962 may have a configuration that is the same as or similar to that of the display 160 of FIG. 1B. The panel 1962 may be implemented as, for example, being flexible, transparent, or wearable. The panel 1962 may be configured as a single module with the touch panel 1952. The hologram device 1964 shows a cubic image in the air by using interference of light. The projector 1966 displays an image by projecting light onto a screen that may be positioned, for example, inside or outside the electronic device 1901. According to an embodiment of the present disclosure, the display 1960 may further include a control circuit for controlling the panel 1962, the hologram device 1964, or the projector 1966.

The interface 1970 may be, for example, a HDMI 1972, an USB 1974, an optical interface 1976, or a D-subminiature (sub) 1978. The interface 1970 may be included in, for example, the communication interface 170. Additionally or alternatively, the interface 1970 may include, for example, a mobile high-definition link (MHL) interface, an SD card/multi-media card (MMC) interface, or an infrared data association (IrDA) standard interface.

The audio module 1980 interchangeably converts sound and an electric signal. At least some components of the audio module 1980 may be included in, for example, the I/O interface 140 illustrated in FIG. 1B. The audio module 1980 may process sound information that is input or output through a speaker 1982, a receiver 1984, an earphone 1986, or a microphone 1988.

The camera module 1991 is a device capable of capturing a still image and a moving image, and according to an embodiment of the present disclosure, may include one or more image sensors (for example, a front sensor or a rear sensor), a lens, an ISP, or a flash (for example, an LED or a xenon lamp).

The power management module 1995 manages power of the electronic device 1901. According to an embodiment of the present disclosure, the power management module 1995 may include a power management integrated circuit (PMIC), a charger IC, or a battery or fuel gauge. The PMIC may use a wired and/or wireless charging scheme. The wireless charging scheme may include, for example, a magnetic resonance scheme, a magnetic induction scheme, or an electromagnetic wave scheme, and an additional circuit for wireless charging, for example, a coil loop, a resonance circuit, or a rectifier may be further included. The battery gauge measures the remaining capacity of the battery 1996, and a voltage, a current, or a temperature of the battery 1996 during charging. The battery 1996 may include, for example, a rechargeable battery and/or a solar battery.

The indicator 1997 displays a specific status, such as a booting status, a message status, or a charging status, of the electronic device 1901 or a part thereof (for example, the AP 1910). The motor 1998 converts an electric signal into mechanical vibration, and generates vibration or a haptic effect. Although not shown, a processing device (for example, a GPU) for supporting a mobile TV may be included. The processing device for supporting the mobile TV processes media data complying with the standard, such as digital multimedia broadcasting (DMB), digital video broadcasting (DVB), or Media Flow.

Each of the above-described elements of the electronic device 801 may include one or more components, and the name of the element may vary with a type of the electronic device. According to various embodiments of the present disclosure, the electronic device may include at least one of the above-described elements, and some elements may be omitted or other elements may be further included. In addition, some of the elements of the electronic device 801 according to various embodiments of the present disclosure may be coupled into one entity to perform the same functions of the elements as those of the elements before coupled.

The term “module” used in various embodiments of the present disclosure may refer to, for example, a “unit” including one of hardware, software, and firmware, or a combination of two or more thereof The term “module” can be interchangeable with other terms, such as unit, logic, logical block, component, or circuit. A “module” may be a minimum unit of integrally configured components or a part thereof A “module” may be a minimum unit for performing one or more functions or a part thereof A “module” may be mechanically or electronically implemented. For example, a “module” according to various embodiments of the present disclosure may include at least one of an application-specific integrated circuit (ASIC) chip, a field-programmable gate arrays (FPGAs), and a programmable-logic device for performing operations which has been known or will be developed in the future.

At least a part of a device (for example, modules or functions thereof) or a method (for example, operations) according to various embodiments of the present disclosure may be implemented by instructions stored in the form of program modules in computer-readable storage media. When the instruction is executed by a processor (for example, the processor 120), the one or more processors may perform a function corresponding to the instruction. The computer-readable storage medium may be, for example, the memory 130.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

The module or program module according to various embodiments of the present disclosure may include at least one of the above-described elements, exclude some of them, or further include other elements. The operations performed by the module, the program module, or other elements according to various embodiments of the present disclosure may be executed in a sequential, parallel, repeated, or heuristic manner. Also, some operations may be executed based on a different order, may be omitted, or may additionally include another operation.

According to various embodiments of the present disclosure, a storage medium has stored therein commands that are set to control at least one processors to perform at least one operations when executed by the at least one processors, in which the at least one operations include obtaining a position of a first base disk image stored in a disk image storage, creating a root disk image that backs the first base disk image based on the obtained position, and executing the VM based on the created root disk image.

The embodiments disclosed herein have been provided for description and understanding of disclosed technical matters, and are not intended to limit the scope of the present disclosure. Therefore, it should be construed that the scope of the present disclosure includes any change or other various embodiments based on the technical spirit of the present disclosure.

As is apparent from the foregoing description, an electronic device may execute a VM based on a root disk image that backs a base disk image stored outside. Thus, the electronic device may execute the VM by backing a remote base disk image without having to download the entire virtual disk image. Thus, the VM may be executed without a need to wait during a time required for downloading the base disk image.

In various embodiments of the present disclosure, the electronic device may download the base disk image in parallel with execution of the VM based on the root disk image. Once downloading is completed, the electronic device may change a backing target for the root disk image from the remote base disk image to the base disk image downloaded inside. The electronic device may execute the VM based on the root disk image that backs the downloaded base disk image. Thus, stable base disk image change may be possible.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for executing a virtual machine (VM) in an electronic device, the method comprising:
obtaining a position of a first base disk image stored in a disk image storage;
creating a root disk image that backs the first base disk image based on the obtained position; and
executing the VM based on the created root disk image.

2. The method of claim 1, further comprising downloading the first base disk image from the disk image storage and storing a second base disk image in the electronic device.

3. The method of claim 2, further comprising controlling the root disk image to back the second base disk image, if the downloading of the first base disk image is completed.

4. The method of claim 3, wherein the controlling of the root disk image to back the second base disk image comprises changing an object that performs data input/output from a first object corresponding to the first base disk image to a second object corresponding to the second base disk image.

5. The method of claim 4, further comprising:
stopping data input/output from the first object; and
resuming data input/output from the second object, if the changing to the second object is completed.

6. The method of claim 2, further comprising:
creating a merged disk image by merging the root disk image and the second base disk image, if the downloading of the first base disk image is completed; and
resuming the VM based on the created merged disk image.

7. The method of claim 6, further comprising deleting the second base disk image.

8. The method of claim 2, further comprising releasing connection with the disk image storage, if the downloading of the first base disk image is completed.

9. The method of claim 1, wherein the obtaining of the position of the first base disk image stored in the disk image storage comprises obtaining a uniform resource locator (URL) of the first base disk image.

10. An electronic device for executing a virtual machine (VM), the electronic device comprising:
a communication interface configured to form communication connection with a disk image storage configured to store a first base disk image; and
a processor configured to:
obtain a position of a first base disk image stored in a disk image storage,
create a root disk image that backs the first base disk image based on the obtained position, and
execute the VM based on the created root disk image.

11. The electronic device of claim 10, further comprising:
a memory,
wherein the communication interface is further configured to download the first base disk image from the disk image storage and stores a second base disk image in the electronic device.

12. The electronic device of claim 11, wherein the processor is further configured to control the root disk image to back the second base disk image, if the downloading of the first base disk image is completed.

13. The electronic device of claim 12, wherein the processor is further configured to change an object that performs data input/output from a first object corresponding to the first base disk image to a second object corresponding to the second base disk image.

14. The electronic device of claim 13, wherein the processor is further configured to:
stop data input/output from the first object, and
resume data input/output from the second object, if the changing to the second object is completed.

15. The electronic device of claim 11, wherein the processor is further configured to:
create a merged disk image by merging the root disk image and the second base disk image, if the downloading of the first base disk image is completed, and
resume the VM based on the created merged disk image.

16. The electronic device of claim 15, wherein the processor is further configured to delete the second base disk image.

17. The electronic device of claim 11, wherein the processor is further configured to release connection with the disk image storage, if the downloading of the first base disk image is completed.

18. The electronic device of claim 10, wherein the processor is further configured to obtain a uniform resource locator (URL) of the first base disk image to back the first base disk image based on the obtained URL.

19. A method for executing a virtual machine (VM) in an electronic device, the method comprising:
executing the VM based on a root disk image that backs a first base disk image stored outside the electronic device;
changing a backing target for the root disk image from the first base disk image to a second base disk image stored inside the electronic device; and
resuming the VM based on the root disk image that backs the second base disk image.

20. The method of claim 19, wherein the changing of the backing target comprises changing an object that performs data input/output from a first object corresponding to the first base disk image to a second object corresponding to the second base disk image.

21. An electronic device for executing a virtual machine (VM), the electronic device comprising:
a communication interface configured to back a first base disk image stored outside the electronic device; and
a processor configured to:
execute the VM based on a root disk image that backs the first base disk image,
change the backing target for the root disk image from the first base disk image to a second base disk image stored inside the electronic device, and
resume the VM based on the root disk image that backs the second base disk image.

22. The electronic device of claim 21, wherein the processor is further configured to change an object that performs data input/output from a first object corresponding to the first base disk image to a second object corresponding to the second base disk image.

23. A method for executing a virtual machine (VM) in an electronic device, the method comprising:
executing the VM based on a root disk image that backs a first base disk image stored outside the electronic device;
downloading the first base disk image and storing a second base disk image inside the electronic device;
merging the root disk image and the second base disk image to create a merged disk image, if the downloading of the first base disk image is completed; and
resuming the VM based on the created merged disk image.

24. The method of claim 23, wherein the root disk image is a write-only disk image.

25. An electronic device for executing a virtual machine (VM), the electronic device comprising:
a communication interface configured to back a first base disk image stored outside the electronic device;
a processor configured to execute the VM based on a root disk image that backs the first base disk image; and
a memory configured to download the first base disk image and to store a second base disk image,
wherein the processor is further configured to:
merge the root disk image and the second base disk image to create a merged disk image, if the downloading of the first base disk image is completed, and
resume the VM based on the created merged disk image.

26. The electronic device of claim 25, wherein the root disk image comprises a write-only disk image.

27. A method for configuring a screen of an electronic device, the method comprising:
displaying a first screen based on a first environment;
obtaining an environment change command requesting change from the first environment to a second environment;
obtaining a position of a base disk image corresponding to the second environment;
creating a root disk image that backs the base disk image; and
displaying a second screen based on the second environment by executing a virtual machine (VM) based on the root disk image.

28. The method of claim 27, wherein the first environment is related to a first operating system (OS) or a first mode, and the second environment is related to a second OS or a second mode.

29. An electronic device comprising:
a display configured to display a first screen based on a first environment;
an input/output interface configured to obtain an environment change command requesting change from the first environment to a second environment; and
a processor configured to:
obtain a position of a base disk image corresponding to the second environment,
create a root disk image that backs the base disk image, and
display a second screen based on the second environment by executing a virtual machine (VM) based on the root disk image.

30. The electronic device of claim 29, wherein the first environment is related to a first operating system (OS) or a first mode, and the second environment is related to a second OS or a second mode.

31. A method for executing a virtual machine (VM) in an electronic device, the method comprising:
executing the VM by backing a first base disk image stored in a disk image storage; and
downloading the first base disk image in parallel with the backing.

32. An electronic device for executing a virtual machine (VM), the electronic device comprising:
a processor configured to execute the VM by backing a first base disk image stored in a disk image storage; and
a communication interface configured to download the first base disk image in parallel with the backing.

33. At least one non-transitory computer readable storage medium for storing a computer program of instructions configured to be readable by at least one processor for instructing the at least one processor to execute a computer process for performing the method of claim 1.
